(19) United States
(12) Patent Application Publication
(10) Pub. No.: US 2012/0129045 A1
(43) Pub. Date: May 24, 2012

(54) LIQUID ELECTROLYTE FILLED POLYMER ELECTROLYTE

(76) Inventors: Douglas L. GIN, Longmont, CO (US); Robert L. Kerr, Longmont, CO (US); Brian J. Elliott, Superior, CO (US)

(21) Appl. No.: 13/237,518

(22) Filed: Sep. 20, 2011

Related U.S. Application Data
(63) Continuation-in-part of application No. PCT/US2010/028370, filed on Mar. 23, 2010.
(60) Provisional application No. 61/162,592, filed on Mar. 23, 2009.

(51) Int. Cl. H01M 10/02

(52) U.S. Cl. 429/189; 429/306; 429/311; 429/317; 429/314

(57) ABSTRACT

A polymer-based electrolyte material for use in lithium ion batteries that exhibits high bulk ion conductivity at ambient and sub-ambient temperatures. The polymer electrolyte comprises a polymer matrix and a liquid electrolyte which is an organic solvent containing a free lithium salt. The polymer matrix is cross-linked and can be formed of cross-linkable ionic monomers, particularly ionic LLC surfactant monomers.

### CROSS-REFERENCE TO RELATED APPLICATIONS

This application claims the benefit of U.S. provisional application Ser. No. 61/162,592, filed Mar. 23, 2009 and is a Continuation-in-part of PCT/US2010/028370 filed Mar. 23, 2010. Each of these applications is incorporated by reference herein in its entirety.

### ACKNOWLEDGEMENT OF GOVERNMENT SUPPORT

This invention was made with government support under grant number DE-FG02-04ER84093 awarded by the U.S. Department of Energy and grant number DMR 0213918 awarded by the National Science Foundation. The government has certain rights in the invention.

### BACKGROUND OF THE INVENTION

This invention relates generally to the field of polymer electrolytes. In one aspect, the invention relates to the use of polymerizable lyotropic liquid crystal surfactant monomers and liquid electrolytes (solvents and dissolved salts) in forming a liquid electrolyte-filled nanoporous polymer electrolyte.

Li ion batteries are used for portable electronics and electric vehicles because of their high energy density, high power delivery, and ability to be recharged over a large number of cycles. [Megahed, S.; Ebner, W. J. Power Sources 1995, 54, 155; Scrosati, B. Electrochim. Acta 2000, 45, 2461, and references therein.] Polymer or liquid electrolytes can be used in Li ion batteries. The typical electrolyte in Li ion batteries is a membrane that consists of a separator material and the electrolyte itself. The separator is typically a polymer (e.g., gelled poly(ethylene oxide), porous polyethylene, polyacrylonitrile, or poly(methyl methacrylate) that prevents contact and electrical conduction between the cathode and the anode (Li metal, lithium-intercalated carbon, etc.), but allows the passage of Li⁺ ions, either by bulk liquid electrolyte in the pores, or diffusion of lithium cations or lithium salt ion pairs in solid or gelled materials. A lithium salt dissolved, blended, or imbedded in the electrolyte material usually provides the Li⁺ ions necessary for ion conduction and cell operation. [Song, J. Y.; Wang, Y. Y.; Wan, C. C. J. Power Sources 1999, 77, 183, and references therein.] High Li ion mobility/conductivity in this electrolyte material is required for high energy applications, and efficient discharge and recharge with a minimum of power loss to resistive heating. [Song et al. (1999) supra; Kerr, J. B. Polymeric Electrolytes: An Overview; in Lithium Ion Batteries Science and Technology; Nazria, G.-A.; Pistoria, G., eds.; Kluwer Academic: Boston, 2004; Chapter 19, both of which are incorporated by reference herein for descriptions of lithium ion batteries.]

Although liquid organic electrolyte solutions containing Li salts provide the highest ion conductivities (10⁻² to 10⁻³ S cm⁻¹ at room temperature), there are inherent problems with the use of a liquid-phase electrolyte in batteries. [Scrosati, B. Electrochim. Acta 2000, 45, 2461, and references therein; Nazri, M. Liquid Electrolytes Some Theoretical and Practical Aspects; in Lithium Ion Batteries Science and Technology; Nazria, G.-A.; Pistoria, G., eds.; Kluwer Academic: Boston, 2004; Chapter 17.] Liquid organic electrolytes can leak from the battery, are flammable, and often have poor chemical, thermal, and electrochemical stability in contact with the highly reducing Li metal anode material. [Song et al. (1999) supra.] Liquid electrolytes form a solid electrolyte interface (SEI) with lithium metal anodes, which becomes larger with subsequent cycling. This increasing layer increases the resistance and also consumes electrolyte. Further, the SEI is thermally unstable and at high temperatures can decompose leading to a highly energetic failure.

Polymeric, solid-state electrolyte materials are the electrolytes of choice in low form-factor Li ion batteries because (1) they can more easily be produced in irregular shapes; (2) they cannot leak from the assembly; and (3) they have better chemical, thermal, and electrochemical stability compared to organic solvents. [Song et al. (1999) supra.] Batteries with solid electrolytes are used in cell phones and computers, in part for safety reasons. However, such batteries do have lower power output as a result of lower ionic conductivity, so high-power lithium batteries are made using a liquid electrolyte (e.g., in hybrid electric vehicles). Solvent-free, uncharged polymer electrolyte materials, such as poly(ethylene oxide) (PEO), act as solid solvents for Li salt conduction. The ion conduction mechanism in uncharged polymer electrolytes involves Li⁺ stabilization and movement via the local segmental motions of the polymer. [Song et al. (1999) supra.] Although quite stable, solvent-free solid polymer electrolytes, such as Li salt-doped PEO, only exhibit Li ion conductivities of 10⁻⁸ to 10⁻⁴ S cm⁻¹ at elevated temperatures between 40-100° C. These PEO materials have conductivity values that are too low at ambient temperature (20-25° C.) for good operation (i.e., less than 10⁻⁴ S cm⁻¹). [Song et al. (1999) supra.] In order to obtain higher Li⁺ ion conductivity values at ambient temperature in these polymer/salt complexes, low molecular weight plasticizers, solvents, or liquid electrolytes have been added to form gelled polymer electrolytes. The added plasticizers or solvents serve to decrease crystallinity in the polymers, increase polymer segmental motion, and increase ion dissociation, all of which lead to higher Li⁺ mobility. [Song et al. (1999) supra.] Gelled polymer electrolytes based on PEO/Li salts swollen with low molecular weight PEO oligomers have been reported to have ion conductivities approaching those in the liquid electrolyte range (10⁻⁸ S cm⁻¹). In these electrolyte materials, up to 70% solvent or liquid electrolyte is required. [Handbook of Batteries, 3rd ed. Linden, D.; Reddy, T. B., Eds.; McGraw-Hill: New York, 2002; Chapter 34, p. 15.]

However, some intrinsic disadvantages of gelled or solvent-swollen polymer electrolytes include potential phase-separation and incompatibility between the polymer and liquid-phase additives, and eventual leaching of the liquid from the composite material. [Song et al. (1999) supra.]

Intrinsically charged, (i.e., ionic) polymers containing associated Li⁺ ions have also been studied as solid Li ion-conducting materials. These ionic polymers are referred to as “polyelectrolytes,” in order to differentiate them from the neutral polymer electrolytes, such as PEO, described previously. Li⁺-containing polyelectrolytes have the advantages of not needing added Li salts to provide conductivity and potentially high Li transference numbers. This is because the negatively charged counterions associated with the Li⁺ ions are covalently attached and immobilized to the polymer matrix and cannot contribute to the ion current. [Song et al. (1999) supra.] Unfortunately, typical solid polyelectrolytes are not sufficiently flexible, and they have room-temperature conductivities only on the order of 10⁻⁶ S cm⁻¹. [Song et al. (1999) supra.] Flexible polyelectrolyte films with conductivities suitable for use in devices have yet to be prepared. [Song et al. (1999) supra.]

U.S. Pat. No. 4,914,161 relates to an ionically conductive macromolecular material containing a salt in solution in a polymer. The salt, particularly a lithium salt, comprises an anion present in the form of a polyether chain, one end of which carries an anionic function. The anions may be polyethers of high molecular weight. Anions include alcoholates, sulfonates, sulfates, phosphates, and phosphonates, among others. The solution referred to appears to be a solid solution of the salt in the polymer material. The patent reports a family of salts, the anions of which are the least mobile when in solution in a polymer and which are completely compatible with the polymer. Macromolecular materials are described as amorphous and of the “polyether type”. The patent reports that the anions may be grafted into the macromolecule. The patent is incorporated by reference herein for descriptions of the macromolecular materials and conductive macromolecular materials and components thereof therein which disclosed species may be specifically excluded from the claims herein.

U.S. Pat. No. 5,116,541 relates to an ion-conductive polymer electrolyte which comprises an organic polymer and a soluble electrolyte salt. The polymer is formed by crosslinking a compound having an average molecular weight of 1,000 to 20,000 having a structure of the following formula:

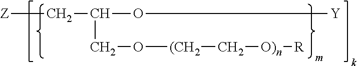

where variables are defined therein and in particular Z is a residue of a compound having at least. one active hydrogen and Y is a hydrogen atom or polymerizable functional group. The formula contains polyether structures. The salt can be doped into the polymer by contacting a solution of the salt in an organic solvent with the polymer and then removing the solvent. The polymer electrolyte does not appear to contain a liquid electrolyte. The patent is incorporated by reference herein for descriptions of the macromolecular materials and conductive macromolecular materials and components thereof therein which disclosed species may be specifically excluded from the claims herein.

U.S. Pat. No. 5,952,126 relates to a polymer solid electrolyte useable in a lithium secondary cell which comprises a polymer matrix, a polymerization initiator, an inorganic salt and a solvent. The polymer matrix is described as composed of a copolymer of a monomer having an amide group at a side chain and a polymer with an oxyethylene repeating unit. The polymer matrix is further described as a copolymer of the following monomer and crosslinking agent:

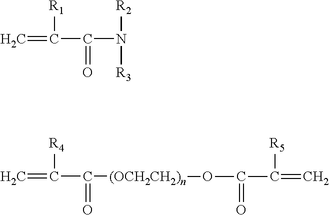

where variables are defined therein. The patent reports gel-type solid electrolytes prepared by polymerizing certain disclosed monomers and crosslinking agents in the presence of a solvent containing a lithium salt. The patent is incorporated by reference herein for descriptions of the macromolecular materials and conductive macromolecular materials and components thereof therein which disclosed species may be specifically excluded from the claims herein.

U.S. Pat. No. 6,080,282 relates to an electrolyte solution for use as a gel electrolyte in an electrolytic cell. The electrolyte solution is described as comprising a polymerizable electrolyte material and a reinforcement polymer. A preferred reinforcement polymer is poly(methyl methacrylate). The polymerizable electrolyte material is described as comprising at least a solvent, a monomer, a polymerization initiator, and an ionic conductor. The use of a reinforcement polymer is said to increase the homogeneity and thus, the coatability of the electrolytic solution, while also improving the mechanical properties of the cured electrolyte gel. A number of monomers are reported to be useful. The reinforcement polymer is reported not to be polymerized during the process of making the gel electrolyte. The patent is incorporated by reference herein for descriptions of the macromolecular materials and conductive macromolecular materials and components thereof therein which disclosed species may be specifically excluded from the claims herein.

U.S. Pat. No. 6,406,817 relates to a crosslinked polymer and an electrolyte containing the crosslinked polymer. The crosslinked polymer is described as being obtained by a crosslinking reaction between a compound (1) having at least two substituents, in total, of at least one kind selected from the group consisting of alpha, beta.-unsaturated sulfonyl, .alpha, beta.-unsaturated nitryl and alpha, beta-unsaturated carbonyl groups in its molecule and a compound (2) having at least two nucleophilic groups in its molecule. The electrolyte is described as containing the crosslinked polymer and a salt. It is reported that the electrolyte can be produced under mild conditions by Michael reaction of compounds (1) and (2) without use of any strong base, by adding, compounds (1) and (2) to an organic solvent containing a salt dissolved therein. Specifically disclosed as examples of compound (2) are:

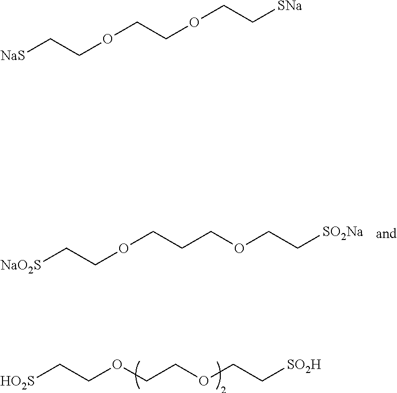

The patent is incorporated by reference herein for descriptions of the macromolecular materials and conductive macromolecular materials and components thereof therein which disclosed species may be specifically excluded from the claims herein.

U.S. Pat. No. 7,198,870 relates to a polymer matrix electrolyte which includes a polyimide, at least one salt and at least one solvent intermixed. The polymer matrix electrolyte is reported to be formed by dissolving a polyimide in at least one solvent, adding at least one salt, particularly a lithium salt, to the polyimide and the solvent, wherein said polyimide, salt and solvent become intermixed. The PME is reported to be soluble in the solvent. The PME of this patent is reported to be substantially optically clear. Specific examples of polyimides, solvents and salts are provided. The patent is incorporated by reference herein for descriptions of the macromolecular materials and conductive macromolecular materials and components thereof therein which disclosed species may be specifically excluded from the claims herein.

U.S. Pat. No. 7,226,549 relates to a solid state ion conducting electrolyte including a polymer with a salt dissolved in the matrix. The polymer is preferably a polyether, such as poly(ethylene oxide) (PEO), and the salt, including a lithium salt, has an anion with a long or branched chain having not less than 5 carbon or silicon atoms therein. The patent is incorporated by reference herein for descriptions of the macromolecular materials and conductive macromolecular materials and components thereof therein which disclosed species may be specifically excluded from the claims herein.

U.S. Pat. Nos. 7,273,677 and 7,125,629 (Satou et al.) relate to a cationic conductor comprising a block copolymer which comprises: a polymer moiety having a structural unit represented by the formula:

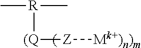

where R represents an organic group obtained via polymerization of monomer compounds having polymerizable unsaturated linkages; Q represents an n+1-valence organic group bonded to R through a single bond; Z represents a functional group capable of forming an ionic bond to or having coordination ability to a cation; M^{k+} represents a k-valence cation; and n and m are each independently an integer of 1 or larger, provided that Z forms an ionic or coordination bond to a cation; and a polymer moiety having addition polymerizable monomers. Alternating copolymers and mixtures of polymers of related formulas are also reported. The polymer structural unit is more specifically described as:

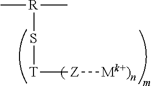

wherein R represents an organic group obtained via polymerization of monomer compounds having polymerizable unsaturated linkages; S represents an organic group bonded to R; T represents an n+1-valence organic group bonded to S through a single bond; and other variables are defined as above. Organic group S is bonded to organic group T through a single bond, and T freely rotates around this single bond which is said to be important for function. Specific examples of Z are oxygen (O⁻), for example as in phenolate anions where an oxygen atom in such anion may be substituted with a sulfur atom, methoxy (—OCH₃) or —OR, where R is alkyl, alkyl thio, ester (—O—C(═O)—R, —C(═O)O—R), an amino group (—NR₁R₂), an acyl group (—C(═O)—R), or carbonate (—O—C(═O)—OR). The patents report polymer electrolytes comprising copolymers and polymer mixtures and alkali metal salts, particularly lithium salts. On review of the examples provided, the electrolytes of the patents comprise polymeric material and salts, but do not appear to contain liquid electrolyte or organic solvent. The patents are incorporated by reference herein for descriptions of the copolymers, polymers and polymer mixtures and polymer electrolytes therein which disclosed species may be specifically excluded from the claims herein.

U.S. Pat. No. 7,238,451 relates to a conductive polyamine-based electrolyte comprising amine groups dispersed throughout the polymer backbone, including various poly(ethylenimine)-based polymers, which are described as enabling ionic movement for use in various applications. Polymer electrolytes are described where the polymer electrolytes are swollen with a metal salt-containing solvent. Polymer electrolytes are described where the metal salts are incorporated into the polymers, and maintained in a dissolved or dispersed state without the need for solvent. The patent is incorporated by reference herein for descriptions of the polymer matrix and polyelectrolyte components therein which disclosed species may be specifically excluded from the claims herein.

U.S. published application 2010/0035159 relates to a polymer electrolyte having a ketonic carbonyl group wherein the weight ratio of the ketonic carbonyl group is in the range of 15 to 50 wt % based on the weight of the polymer material. The polymer electrolytes that are all-solid-state polymer electrolytes or that are gel-state polymer electrolytes are described. Specific polymer materials having a ketonic carbonyl group are described as including polymers of unsaturated monomers having a ketonic carbonyl group, including unsaturated ketone compounds such as methyl vinyl ketone, ethyl vinyl ketone, n-hexyl vinyl ketone, phenyl vinyl ketone, and methyl isopropenyl ketone. Polymer materials are further described as including copolymers of such monomers and other unsaturated monomers. Several methods for making polymer electrolyte are described, including dissolving a polymer material and an electrolyte salt in a solvent that can dissolve both of them, and then removing part or the whole of the solvent (method I) or by first forming a polymer material into a film, impregnating it into a solution dissolving an electrolyte salt in a solvent to swell followed by removing part or the whole of the solvent. Additional details of the polymer matrix are provided in the reference which is incorporated by reference herein in its entirety for such details of the components of the polymer electrolyte and methods of making and using such polymer electrolytes. Species disclosed therein may be specifically excluded from the claims herein.

Published EP application 1098382 (published May 9, 2001) relates to a polyelectrolyte gel which includes a polymer or co-polymer matrix and at least one substantially non-aqueous polar solvent. A preferred embodiment is described as having a polymer or co-polymer matrix including at least one monomer having a side chain carrying an alkali metal and at least one monomer having a polar moiety. Several specific examples of such monomers are provided. An example of the monomer having a side chain carrying an alkali metal is:

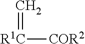

where wherein R¹ represents H or CH₃ and R² represents —NH—C(CH₃)₂CH₂—SO₃-M or —O-M wherein M is an alkali metal, particularly lithium. An example of the monomer having a polar moiety is:

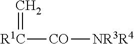

where R¹ represents H or CH₃ and each of R³ and R⁴ is selected from H, CH₃, CH₂—CH₃, CH(CH₃)₂, (CH₂)₃CH₃ or C₆H₅. The polyelectrolyte gel is described as having negatively charged ions attached to its backbone and alkali metal ions associated with the negatively charged ions. The gel is described as acting as a single ion conductor. The polyelectrolyte gel does not appear to contain alkali metal ions other than those associated with the polymer. A related reference, Travas-Sejdic et al. Electrochemica Acta 46 (2001) 1461-1466, relates to a polyelectrolyte gel system for application in secondary polymer lithium batteries. The gel is reported to be a copolymer of N,N-dimethylacryl amide and lithium 2-acrylamido-2-methyl-1-propane sulphonate chemically cross-linked to form a three-dimensional network. The gel is reported polymerized in a solvent mixture of N,N-dimethylacetamide and ethylene carbonate. All gels investigated were reported to contain 5% (wt:vol) of fumed silica (TS-530, Cab-o-Sil) in order to improve mechanical properties of the material. The reference provides additional details of the composition and properties of the gels formed. The reference is incorporated by reference herein for descriptions of polymer matrix, monomers and polymer electrolytes therein which disclosed species may be specifically excluded from the claims herein.

U.S. Pat. No. 6,727,019 relates to an ionomer binder in which an electroactive material is at least partially dispersed. The electroactive material is associated with at least a portion of a current collecting substrate in an electrochemical cell. The ionomer binder is said to preferably comprise 2-acrylamido-2-methyl-1-propane sulphonate (LiAMPS), a combination of LiAMPS and N,N-dimethylacrylamide (DMAA), and/or a combination of DMAA-co-LiAMPS copolymer and PVDF. The patent provides additional details of the ionomer binder and electroactive material. The patent is incorporated by reference herein in its entirety for such details and disclosed species therein may be specifically excluded from the claims herein.

U.S. Pat. No. 7,422,826 relates to an in situ thermal polymerization method for making gel polymer lithium ion rechargeable electrochemical cells. A precursor solution is described as consisting of monomers with multiple functionalities (e.g., acryloyl functionalities), a free-radical generating activator, nonaqueous solvents (e.g., ethylene carbonate and propylene carbonate) and a lithium salt (e.g., LiPF₆.). Electrodes are prepared by slurry-coating a carbonaceous material such as graphite onto an anode current collector and a lithium transition metal oxide such as LiCoO₂ onto a cathode current collector, respectively. The electrodes, together with a highly porous separator, are then soaked with the polymer electrolyte precursor solution and sealed in a cell package under vacuum. The whole cell package is heated to cure the polymer electrolyte precursor in situ. This patent is incorporated by reference herein in its entirety for its descriptions of components of gels and for in situ methods of making polymer gels. Species disclosed therein may be specifically excluded from the claims herein.

U.S. Pat. No. 6,033,804 relates to a highly fluorinated lithium ion exchange polymer electrolyte membrane (FLIEPEM) which exhibits ionic conductivity in non-aqueous media of at least 10⁻⁴ S/cm. The polymer is described as having pendant fluoroalkoxy lithium sulfonate groups, where the polymer is either completely or partially cation exchanged and where at least one aprotic solvent is imbibed in said membrane. This patent is incorporated by reference herein. The patent discloses details of polymers useful for FLIEPEM and is incorporated by reference herein in its entirety for such details and disclosed species therein may be specifically excluded from the claims herein.

U.S. Pat. No. 6,787,269, U.S. Pat. No. 7,150,944 and U.S. Pat. No. 7,223,500 relate to non-aqueous electrolytes for use as liquid electrolytes. These patents provide examples of organic solvents and mixture. Other useful additives are also described. U.S. Pat. No. 7,504,181 relates to non-aqueous electrolytes for use as liquid electrolytes in which a macromolecular material is added to the liquid electrolyte. A polyether macromolecular material is exemplified. Each of these patents is incorporated by reference herein in its entirety for descriptions of such solvents, solvent mixtures and salts.

U.S. Pat. No. 6,372,387 relates to a secondary battery comprising an ion conductive membrane having a layered or columnar structure which is sandwiched between negative and positive electrodes. This patent is incorporated by reference herein in its entirety for its description of certain aspects of secondary battery elements. U.S. Pat. No. 7,105,254 relates to polymer electrolyte comprising a polymer gel holding a non-aqueous solvent containing an electrolyte. The polymer gel is described as comprises (I) a unit derived from at least one monomer having one copolymerizable vinyl group and (II) a unit derived from at least one compound selected from the group consisting of (II-a) a compound having two acryloyl groups and a (poly)oxyethylene group, (II-b) a compound having one acryloyl group and a (poly)oxyethylene group, and (II-c) a glycidyl ether compound, particularly the polymer gel comprises monomer (I), compound (II-a), and a copolymerizable plasticizing compound. U.S. patent application 2007/0218571, published September 2007, relates to a nanoporous polymer electrolyte. The polymer electrolyte comprises a crosslinked self-assembly of polymerizable salt surfactant, wherein the crosslinked self-assembly included nanopores and the crosslinked self-assembly has conductivity of 1×10⁻⁶ S/cm at 25° C. This reference is incorporated by reference herein for its description of polymer electrolyte and polymerizable salt surfactant any of which description may be used to exclude species from the claims herein.

### SUMMARY OF THE INVENTION

The invention provides a polymer-based electrolyte material, particularly for use in lithium ion batteries that exhibit high bulk ion conductivity at ambient and sub-ambient temperatures.

The invention provides a polymer electrolyte that is a composite of a polymer matrix and a liquid electrolyte, wherein the polymer matrix comprises one or more cross-linked ionic polymers, and the liquid electrolyte comprises an organic solvent and a free salt, wherein in the composite, the liquid electrolyte is contained within the polymer matrix. The term “free salt” is used herein to refer to a salt that is dissolved in the organic solvent and is not covalently bonded to the polymer matrix. The term “contained” is used to refer to the presence of the liquid electrolyte in the polymer electrolyte. The liquid electrolyte is retained as a liquid phase in the polymer electrolyte, but does not leak out of the material. The polymer matrix is formed by in situ polymerization/cross-linking of one or more polymer matrix precursors, wherein at least one of the polymer matrix precursors is a cross-linkable ionic monomer. Cross-linking in the polymer matrix is at least in part covalent cross-linking. More specifically, at least one of the polymer matrix precursors is a cross-linkable monomer which is a lithium salt and the free salt is a lithium salt. In specific embodiments, the polymer matrix is formed by cross-linking of one or more ionic polymer precursors, particularly where such precursors are lithium salts. In specific embodiments, the polymer matrix consists essentially of cross-linked/polymerized ionic monomers, wherein there may be one or more different ionic monomers, which are salts of the same alkali metal and wherein the one or more ionic monomers are lithium salts. The free salt in the liquid electrolyte can be a mixture of one or more salts of the same alkali metal and preferably the free salts are lithium salts.

The polymer electrolyte can be a film or coating formed on a surface. The surface can be a surface of an anode or cathode, particularly the anode, cathode or both of a lithium battery. The polymer electrolyte can be formed as a free-standing film or layer (not associated with or supported on a surface). Such free-standing films or layers may, after formation, be layered with other films or layers, or positioned upon a surface. The polymer electrolyte may be formed into a shaped element of selected dimensions, e.g., thickness. The film or coating can be formed, for example, in situ on a surface by cross-linking one or more polymer matrix precursors in the presence of the liquid electrolyte. In specific embodiments, a polymer electrolyte formed into a film can have a thickness ranging from 1 micron to 100 microns. In other specific embodiments, such a film, particularly a film formed on a surface, can range in thickness from 1-50 microns or from 1-20 microns. In other specific embodiments, such a film, particularly a free-standing film, can range in thickness from 5 to 50 microns or from 5 to 20 microns.

In a specific embodiment, the polymer electrolyte of this invention consists essentially of a polymer matrix containing a liquid electrolyte within the polymer matrix. The liquid electrolyte in turn in specific embodiments consists essentially of one or more aprotic solvents and a free lithium salt. In these embodiments, the polymer electrolyte and the liquid electrolyte do not contain any other additive that has a significant effect on conductivity of the polymer electrolyte. In these embodiments, the polymer electrolyte and the liquid electrolyte do not contain a liquid crystal or salt thereof. In these embodiments, the polymer electrolyte and the liquid electrolyte do not contain any substantial amount of polymerizable material other than minor amounts of residual unreacted polymerizable material that remains after formation of the polymer matrix. In a specific embodiment, the polymer electrolyte of this invention consists of a polymer matrix containing a liquid electrolyte within the polymer matrix wherein the liquid electrolyte consists of one or more aprotic solvents as defined herein and a lithium salt.

The invention also provides a polymer electrolyte matrix precursor material which comprises monomer and any cross-linking agent for forming the cross-linked ionic polymer matrix and a liquid electrolyte comprising an organic solvent and a free salt, wherein the ionic monomer and the free salt are salts of the same alkali metal, and most particularly are both lithium salts. In an embodiment, the one or more polymer matrix precursors include at least one which is a cross-linkable ionic monomer. In an embodiment, the polymer electrolyte matrix precursor material can be intrinsically cross-linkable, or cross-linked by addition of a cross-linking agent and subjecting the material and cross-linking agent to polymerizing/cross-linking reaction conditions. In an embodiment, the polymer electrolyte matrix precursor material can be intrinsically cross-linkable and the precursor material is retained under conditions such that polymerization/cross-linking does not occur until it is desired to form the polymer matrix of the polymer electrolyte, such as when the precursor material is contacted with a surface upon which it is intended that the polymer electrolyte be formed. The polymer electrolyte matrix precursor material can in an embodiment also contain a cross-linking agent wherein the precursor material is retained under conditions such that polymerization/cross-linking does not occur until it is desired to form the polymer matrix of the polymer electrolyte.

In specific embodiments, the liquid electrolyte comprises one or more aprotic organic solvents. In other embodiments, the solvent of the liquid electrolyte comprises a mixture of two or more aprotic solvents. In other embodiments, the solvent of the liquid electrolyte consists of one or more aprotic solvents. In other embodiments, the solvent of the liquid electrolyte consists of two or more aprotic solvents. In other embodiments, the solvent of the liquid electrolyte consists of a mixture of two aprotic solvents. In specific embodiments, the solvents are alkylene carbonates or ethers or combinations thereof. In more specific embodiments, the solvents of the liquid electrolyte are selected from propylene carbonate, ethylene carbonate, or mixtures thereof. The liquid electrolyte is not a liquid crystal, is not polymerizable and is not a polymerizable liquid crystal.

The invention further relates to a lithium battery assembly comprising an anode and a cathode wherein the anode, the cathode or both comprise a film, coating or layer which is a polymer electrolyte of this invention. The invention also relates to a method of making such a battery assembly by contacting an anode, a cathode or both thereof with the polymer electrolyte matrix precursor material which contains or to which is added a cross-linking agent and polymerizing/cross-linking the cross-linkable monomers of the precursor material in situ in contact with the anode, cathode of both.

The resulting polymer matrix does not flow if you apply sheer and as such is not a thermodynamic liquid or fluid. Liquids (and fluids) are systems of molecules that are disordered and are not rigidly bound. Liquid crystals are systems of molecules that are ordered, but not rigidly bound. The polymer matrix being formed from cross-linked ionic monomers may or may not be ordered (generally they are), but they are rigidly bound once they are cross-linked. Prior to cross-linking they are not rigidly bound. Thus, before cross-linking they are fluids or liquids (or liquid crystals if they have order), but after they are cross-linked they are not liquids, rather they are solids or polymer macromolecules that contain a liquid (the solvent plus free salt). The polymer matrix being formed from cross-linked monomers has no melting point. The polymer matrix may be mechanically rigid or mechanically deformable, but the cross-linkable ionic monomers are rigidly bound together by covalent chemical bonds. They can only be separated by chemical reactions that break covalent bonds, or by other forces strong enough to break a covalent bond. The bulk polymer matrix may also be substantially non-compressible or compressible.

In a specific embodiment, the polymer electrolytes of this invention include a cross-linked polymer matrix and do not require addition of inorganic fillers to increase the mechanical strength of the electrolyte material. In a specific embodiment, the polymer electrolytes of this invention include a cross-linked polymer matrix and do not require addition of reinforcing polymers such as polyacrylates or methylmethacrylate to increase the mechanical strength of the electrolyte material. In specific embodiments, the polyelectrolytes herein do not contain materials such as fumed silica particles to provide suitable mechanical properties for film formation.

In specific embodiments, the polymer electrolytes of the invention are prepared by in situ cross-linking of selected ionic monomers, particularly those that form LLC phases in the presence of liquid electrolyte. In specific embodiments, the polymer electrolytes herein do not include pre-formed polymers. In specific embodiments, the polymer electrolytes of this invention exhibit LLC order. In specific embodiments, the polymer electrolytes of this invention exhibit LLC order and are phase-separated.

In a specific embodiment, the at least one cross-linkable ionic monomer is a monomer in which one or more anionic groups are covalently bonded to the monomer. More specifically, the one or more anionic groups are anions other than carboxylates. More specifically, the one or more anionic groups are —SO₃⁻ or —PO₃²⁻ and lithium salts of such groups, which are covalently bonded to the monomer. In other embodiments, the polymer matrix is formed by cross-linking of monomers, all of which monomers are ionic monomers, particularly those in which an anion is covalently bonded to the monomer. In specific embodiments, the cross-linkable ionic monomers are selected from those of formulas herein below. In an embodiment, the polymer matrix consists essentially of cross-linked ionic monomers, particularly anionic monomers. In specific embodiments, the polymer matrix does not contain a polymer which is not cross-linked into the matrix. In specific embodiments, the polymer matrix does not contain poly(ethylene oxide). In specific embodiments, the polymer matrix does not contain poly(methyl methacrylate). In specific embodiments, the polymer matrix does not contain a cross-linked polyether. In specific embodiments, the polymer matrix does not contain and the polymer matrix precursor does not contain a polyamine. In specific embodiments, the polymer matrix does not contain and the polymer matrix precursor does not contain a poly(ethylenimine) or a poly(propylenimine). In specific embodiments, the polymer matrix does not contain and the polymer matrix precursor does not contain polyvinylidene fluoride, polyacrylonitrile, polyethylene oxide, polyvinyl chloride, polyacrylate, or mixtures there of.

In a specific embodiment, the polymer electrolyte matrix precursor material does not contain a pre-formed polymer. In specific embodiments the polymer electrolyte matrix precursor material does not contain a cross-linkable polyether monomer. In specific embodiments the polymer electrolyte matrix precursor material does not contain a cross-linkable monomer that polymerizes to form a polyether. In specific embodiments the polymer electrolyte matrix precursor material does not contain a monomer that polymerizes to form a polyether. In specific embodiments the polymer electrolyte matrix precursor material does not contain a cross-linkable monomer that polymerizes to form a polyamine. In specific embodiments the polymer electrolyte matrix precursor material does not contain a monomer that polymerizes to form a polyamine. In specific embodiments, ionic monomers are ionic monomers other than those that form polyethers or polyamines on polymerization. In specific embodiments, the polymer electrolyte matrix precursor material does not contain poly(ethyleneoxide). In specific embodiments, the polymer electrolyte matrix precursor material does not contain poly(methyl methacrylate).

In specific embodiments, polymer electrolytes of this invention do not contain polymers which are not covalently cross-linked into the polymer matrix. In specific embodiments, polymer electrolytes of this invention do not contain electroactive material.

In one aspect, the invention provides a polymer electrolyte comprising a polymer matrix that does not have any particular predominating crystal structure, pore structure, or molecular ordering. The term “predominating” is used herein to indicate that 50% or more by volume of the polymer matrix has the same crystal structure, pore structure or molecular ordering. The matrix may, for example, comprise portions with one or more liquid crystal phases or portions that are non-ordered, or isotropic.

In more specific embodiments, the invention provides a polymer electrolyte comprising a polymer matrix wherein at least a portion of the polymer matrix is an ionic polymer and a liquid electrolyte where the liquid electrolyte is present in the composite at a concentration from 10 to 90 wt %, more preferably where the liquid electrolyte is present at a concentration from about 30 wt % to about 80 wt %, more preferably where the liquid electrolyte is present at a concentration of about 50 wt %. In other embodiments, the polymer electrolyte of the invention comprises 5 wt % to 30 wt % liquid electrolyte or 5 wt % to 20 wt % liquid electrolyte. In yet other embodiments, the polymer electrolyte of the invention comprises 10 wt % to 40 wt % liquid electrolyte. In yet other embodiments, the polymer electrolyte of the invention comprises 20 wt % to 30 wt % liquid electrolyte.

In specific embodiments, the concentration of lithium salt in the liquid electrolyte ranges from about 0.05 Molar to about 2.0 Molar. More preferably, the lithium salt concentration ranges from 0.1 to 1.5 Molar or 0.1 to 1.0 Molar. Additionally, the lithium salt concentration can range from 0.1 to 0.6 M. In specific embodiments, the lithium salt concentration ranges from 0.6 to 1.5 M. In specific embodiments, the lithium salt concentration ranges from 0.75 to 1.25 M. In other specific embodiments, the lithium salt concentration is 1.0 M.

Solvents or solvent mixtures useful in the invention are liquid at the temperature(s) at which the polymer electrolyte is to be used. In a specific embodiment, the solvent or solvent mixture is liquid at ambient temperature. The solvent is preferably non-reactive toward lithium. Solvents useful in the polymer electrolytes herein include cyclic ethers, e.g., tetrahydrofuran (THF), 2-methyl tetrahydrofuran, or dioxolane; non-cyclic ethers, e.g., alkoxyalkanes, such as dimethoxymethane, 1,2-dimethoxyethane, diethoxymethane or 1,2-diethoxyethane; cyclic carbonates, e.g., ethylene carbonate, propylene carbonate and other alkylene carbonates; non-cyclic carbonates, e.g., dimethylcarbonate, diethylcarbonate and other dialkylcarbonates; cyclic esters, e.g., gamma-butyrolactone or gamma-valerolactone; methylformate; dimethyl sulfoxide; dimethyl sulfite; nitromethane; acetonitrile or miscible mixtures thereof. In specific embodiments, the solvent is propylene carbonate, ethylene carbonate or mixtures thereof. In specific embodiments, the solvent is a mixture of propylene carbonate and/or ethylene carbonate with one or more of 1,2-dimethoxyethane, dimethoxymethane, diethoxymethane, or 1,2-diethoxyethane. In specific embodiments, solvents useful in the polymer electrolytes include solvent mixtures containing from 30-60% (by volume) propylene carbonate and/or ethylene carbonate and from 70-40% (by volume) of one or more of 1,2-dimethoxyethane, dimethoxymethane, diethoxymethane, or 1,2-diethoxyethane.

In more specific embodiments, the polymer matrix contains portions of lyotropic liquid crystal order, i.e. at least a portion of the matrix exhibits such order. The polymer matrix, for example, can comprise one or more lyotropic liquid crystal phases, optionally in combination with isotropic portions. In another specific embodiment, the polymer matrix is predominantly isotropic (i.e., 50% or more by volume, non-ordered) material. In another specific embodiment, the polymer matrix is substantially isotropic (i.e., 95% or more by volume, non-ordered) material.

In embodiments herein, the polymer electrolyte of the invention exhibits ion conductivity of 10⁻⁴ S cm⁻¹ or higher at 23° C. In embodiments herein, the polymer electrolyte of the invention exhibits ion conductivity of 10⁻³ S cm⁻¹ or higher at 23° C.

In an embodiment, this polymer-based electrolyte material comprises a cross-linked ionic polymer matrix and a liquid electrolyte which is retained in the polymer matrix. In an embodiment, the polymer electrolyte comprises a phase-separated, cross-linked nanoporous lyotropic liquid crystal (LLC) polymer of an ionic, polymerizable/cross-linkable Li salt surfactant (monomer) that self-organizes around a small amount of non-aqueous solvent containing a Li salt. In another embodiment, the polymer matrix is formed at least in part from polymerizable/cross-linkable surfactant monomers comprising ionic, particularly anionic, polymerizable surfactants. In another embodiment, the polymer matrix is formed from a mixture of ionic, preferably anionic, polymerizable/cross-linkable surfactant monomers and non-ionic polymerizable/cross-linkable polymerizable surfactants. In another embodiment, the polymer matrix is formed from a mixture of ionic, preferably anionic, polymerizable/cross-linkable surfactant monomers and non-ionic polymerizable/cross-linkable polymerizable surfactants, wherein the mixture comprise 50 wt % or more of ionic surfactant monomers. In another embodiment, the polymer matrix is formed from a mixture of ionic, preferably anionic, polymerizable/cross-linkable surfactant monomers and non-ionic polymerizable/cross-linkable polymerizable surfactants wherein the mixture comprise 75 wt % to 95 wt % more of ionic surfactant monomers.

In an embodiment, a bicontinuous cubic LLC phase is formed in the polymer matrix. In another embodiment, substantially all of the polymer matrix is in the form of a bicontinuous cubic LLC phase, where substantially means 95% or more by volume of the polymer matrix. In another embodiment, the polymer matrix is predominantly (50 wt % by volume or more) in the form of a bicontinuous cubic LLC phase. In another embodiment, 10% or more by volume of the polymer matrix is in the form of a bicontinuous cubic LLC phase.

In specific embodiments, the liquid electrolyte represents from 1% to less than 50% by weight of the polymer electrolyte and in more preferred embodiments represents from 5% to 35% by weight of the polymer electrolyte and in yet more preferred embodiments represents from 10% to 20% by weight of the polymer electrolyte. In other specific embodiments, the liquid electrolyte represents from 10% to 30% by weight of the polymer electrolyte. In other specific embodiments, the liquid electrolyte represents from 20% to 30% by weight of the polymer electrolyte. In more specific embodiments, the liquid electrolyte represents 15 wt %, 23-24 wt %, or 28-29 wt % of the polymer electrolyte.

In another embodiment, the Li salt concentration in the liquid electrolyte ranges from about 0.05 M to about 2.0 M and more specifically ranges from 0.1 M to 1 M (moles/liter).

In specific embodiments, polymer electrolytes of this invention, which comprise liquid electrolyte which contains free lithium salt therein, can exhibit 100-fold or higher increased conductivity compared to analogous polymer electrolytes where the liquid electrolyte does not contain free lithium salt.

In specific embodiments, polymer electrolytes of this invention comprising a cross-linked polymer matrix of ionic monomers which exhibit improved bonding to substrates such as would be used as cathode materials.

In specific embodiments, the polymer matrix is formed by in situ cross-linking and the polymer electrolyte is formed by in situ cross-linking in the presence of liquid electrolyte. In an embodiment, upon in situ cross-linking, a flexible but mechanically stable, nanostructured polyelectrolyte (i.e., an ionic polymer) matrix is obtained comprising nanochannels containing solvent and free Li salt ions. The incorporated solvent is contained within nanopores of the structure. In an embodiment, a resulting solid-liquid nanocomposite material with Li salt concentration ranging from about 0.05 M to 2.0 M is formed. In specific embodiments, the polymer electrolyte exhibits an ion conductivity of 10⁻⁴ S cm⁻¹ or higher at 23° C. even at free Li salt concentrations as low as 0.2-0.3 M. This value is comparable to, or better than, that of traditional Li ion battery polymer electrolytes based on highly solvent-swollen, non-charged polymers such as poly(ethylene oxide) which is typically doped with Li salt solutions at a higher 1 M concentration. In other specific embodiments, the polymer electrolyte exhibits an ion conductivity of 10⁻³ S cm⁻¹ or higher at 23° C. at free Li salt concentrations of about 1 M.

The phase-separated, ordered, nanoporous structure of this composite material can provide good liquid-solution-like Li⁺ mobility, but in a flexible, solid polymer format. In an embodiment, this doped, liquid-filled polyelectrolyte material retains its ion conductivity longer than traditional Li polymer electrolytes at low temperatures. The extremely small diameter Li ion-containing liquid-filled nanopores in this composite material can also afford suppression of Li metal dendrite growth during secondary battery cycling, which is a problem in conventional polymer-based electrolytes.

In embodiments, the polymer electrolyte comprises an ordered, yet fluid assembly of LLC materials in the presence of an immiscible liquid. In an embodiment, the immiscible liquid is water and in another is a solvent or mixture of solvents that are useful in liquid electrolytes, such as alkylene carbonates. In another embodiment, the polymer electrolyte comprises LLC materials having hydrophobic tail sections and hydrophilic headgroups where the LLC tails form hydrophobic regions and the LLC hydrophilic headgroups define the interfaces of ordered domains enclosing the immiscible liquid.

In embodiments, the polymer electrolyte is formed from an ordered, yet fluid assembly of LLC materials in the presence of an immiscible aprotic solvent or a mixture of aprotic solvents that are useful in liquid electrolytes, such as cyclic or non-cyclic alkylene carbonates, ethers In another embodiment, the polymer electrolyte is formed from LLC materials having hydrophobic tail sections and hydrophilic headgroups where the LLC tails form hydrophobic regions and the LLC hydrophilic headgroups define the interfaces of ordered domains enclosing the immiscible liquid.

The polymer of the polymer electrolyte is not a liquid crystal, it is in specific embodiments formed from liquid crystal. In such embodiments, the polymer is formed by cross-linking of the liquid crystal and the polymer so formed retains the structural order of the liquid crystal, but is not a liquid.

In a specific embodiment of the invention, a polymerizable non-aqueous ionic LLC system forms a type II bicontinuous cubic (Q_{II}) phase in the presence of Li-salt-doped aprotic solvent, which serves as both the LLC solvent and a mobile ion transport medium. In a very specific embodiment, this doped, non-aqueous LLC system is based on a lithium sulfonate LLC monomer, as exemplified by compound I, and contains ordered, 3-D interconnected liquid nanochannels (see, FIGS. 2A and 2B). The Q_{II} phase can be cross-linked with retention of the LLC morphology to give a unique nanostructured, liquid-channeled polyelectrolyte material with good mechanical flexibility and liquid electrolyte retention. More importantly, the solid-liquid nanocomposite electrolyte material can exhibit a high liquid solution-like ion conductivity of 10⁻⁴ to 10⁻³ S cm⁻¹ at 23° C.

In a specific embodiment of the invention, a polymerizable non-aqueous ionic LLC system forms a type II bicontinuous cubic (Q_{II}) phase in the presence of Li-salt-doped propylene carbonate (PC) solutions, which serves as both the LLC solvent and a mobile ion transport medium. In a very specific embodiment, this doped, non-aqueous LLC system is based on a lithium sulfonate LLC monomer, as exemplified by compound 1, and contains ordered, 3-D interconnected liquid nanochannels (see, FIGS. 2A and 2B). The Q_{II} phase can be cross-linked with retention of the LLC morphology to give a unique nanostructured, liquid-channeled polyelectrolyte material with good mechanical flexibility and liquid electrolyte retention. More importantly, the solid-liquid nanocomposite electrolyte material can exhibit a high liquid solution-like ion conductivity of 10⁻⁴ to 10⁻³ S cm⁻¹ at 23° C.

In materials of the invention, operationally useful conductivity performance can be achieved at relatively low Li salt concentrations (of about 0.2M) where, in contrast, traditional gelled polymer electrolytes require Li salt concentration of 1.0 M to obtain conductivities of similar magnitude. Traditional gelled polymer electrolytes typically require 70 wt % liquid electrolyte for good performance. In contrast, in certain embodiments, the use of much lower amounts of liquid electrolyte provides useful performance. The polyelectrolyte materials of the invention also can have good retention of ion conductivity at sub-ambient temperatures.

In specific embodiments, conductivity of 5×10−4 or higher (at 23° C.) can be achieved with polymer electrolytes of this invention having 20 wt %-30 wt % liquid electrolyte at Li salt concentration of about 1 M.

In additional embodiments, the invention provides polyelectrolyte films, including free-standing films and films or coating formed on substrate surfaces, as well as layers, and shaped elements of polymer electrolytes as described herein. The invention also provides methods of making polymer electrolyte materials by in situ cross-linking of polymerizable/cross-linkable monomers as described herein. The invention additionally provides lithium batteries comprising polymer electrolyte material as described herein.

Other aspects and embodiments of the invention will be apparent on review of the specification including the figures and detailed description.

### BRIEF DESCRIPTION OF THE DRAWINGS

FIG. 1 illustrates an ideal phase progression of LLC phases formed by surfactants in water, and some common LLC phase designations.

FIGS. 2A and 2B illustrate a schematic representation of the formation of the non-aqueous, PC/Li salt solution-channeled LLC polyelectrolyte material. The gray regions are the hydrophobic regions formed by the organic tails of the LLC monomers. The white open regions are the Li-salt-doped liquid PC nanodomains. FIG. 2B is an enlarged view of an exemplary organic bilayer formed in the LLC material.

FIG. 3A provides an XRD profile of the QII phase containing 15 wt % (0.245 M LiClO₄-PC). FIG. 3B is a room-temperature phase diagram of exemplary monomer 1 with (0.245 M LiClO₄-PC) as the polar solvent as a function of increasing liquid electrolyte. The arrow with 3A indicates 15 wt % (0.245 M LiClO₄-PC).

FIG. 4 provides FT-IR spectra of a QII-phase monomer 1-PC film containing 15 wt % PC before (A) and after (B) photo-polymerization with 365 nm UV light for 60 min.

FIG. 5 is the XRD profile of the cross-linked QII phase of 1 containing 15% pure PC. Diffraction peaks corresponding to the characteristic 1/√6, 1/√8, 1/√9, 1/√10, 1/√11, and 1/√12 d-spacings of a Q phase are indexed. [Luzzati, V.; Mustacchi, H.; Skoulios, A.; Husson, F. Acta Crystallogr. 1960, 13, 660.].

FIG. 6 is a schematic representation of typical Nyquist plots, and how conductivity values are extrapolated from the plot features.

FIG. 7 is a Nyquist plot for a cross-linked QII film of 1 containing 15 wt % (0.245 M LiClO₄⁻PC). The x-intercept is the extrapolated solution resistance.

FIG. 8 is a Nyquist plot for a cross-linked QII phase film of 1 containing 15 wt % pure (i.e., undoped) PC. The approximate conductivity for this sample is 2×10⁻⁶ S cm⁻¹.

FIG. 9 provides an XRD profile of cross-linked 50 wt % (0.245 M LiClO₄⁻PC)/Monomer 1, indicating low level of ordering and confirming the presence of an LLC phase.

FIG. 10 is a Nyquist plot for the cross-linked material of FIG. 9.

FIG. 11 provides an XRD profile of cross-linked 30 wt % (0.245 M LiClO₄⁻PC)/Monomer 1, indicating low level of ordering and confirmed the presence of an LLC.

### DETAILED DESCRIPTION OF THE INVENTION

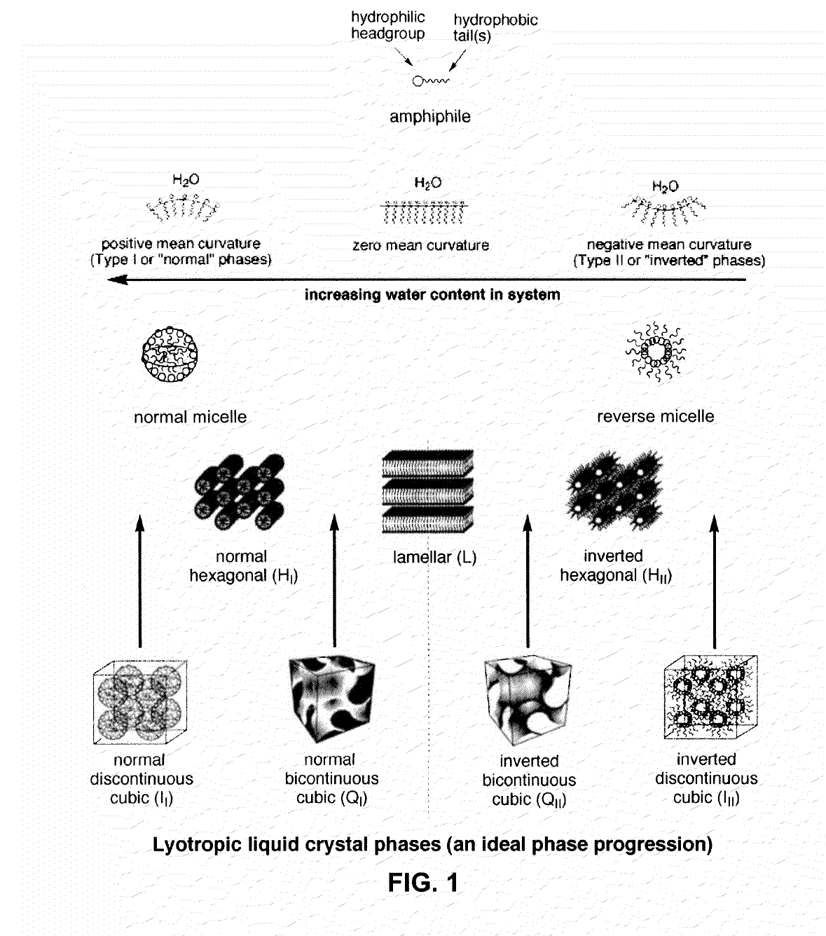

The invention provides polymer electrolytes, particularly for use in lithium batteries, which comprise an ionic polymer matrix I and a liquid electrolyte retained in the polymer matrix. In embodiments, the invention provides polymer electrolyte that comprises lyotropic liquid crystal (LLC) materials. LLCs are generally defined as amphiphilic molecules (i.e., surfactants) containing a hydrophobic organic tail section and a hydrophilic headgroup that can self-organize into ordered, yet fluid, assemblies in the presence of an added immiscible liquid, typically water, but which may be organic solvent as illustrated herein. The amphiphilic character of these molecules encourages them to phase-separate, with the tails forming cross-linking hydrophobic regions and the hydrophilic headgroups defining the interfaces of ordered domains enclosing the immiscible liquid (e.g., water) component (FIG. 1). [Tiddy, G. J. T. Phys. Rep. 1980, 57, 1, and references therein; Seddon, J. M. Biochim. Biophys. Acta 1990, 1031, 1-69 and references therein.]

In comparison to traditional gelled polymer electrolyte materials,³ the Li salt-doped and PC-based LLC material described herein is quite different in that much less liquid electrolyte or solvent is needed (e.g. 15 wt % vs.≦70 wt %) in order to achieve similar bulk ion conductivity. Moreover, the solvent or liquid electrolyte is contained in phase-separated, liquid-filled nanopores, not a solvent-dissolved/gelled polymer. The material of the invention is also very different from traditional macroporous separator systems containing liquid electrolyte in that the pores in the inventive material can be so small that liquid is not lost/leached out, and Li dendrites cannot easily penetrate.

In addition to a Li ion conductivity of 10⁻⁴ S cm⁻¹ or higher, and better chemical and configurational stability, other benefits of using Li salt-doped PC and related organic electrolyte solutions for nanoporous LLC polyelectrolyte formation include a broad temperature range over which good ion conductivity can be achieved. This is particularly the case when PC is employed because PC has a high boiling point (242° C.) and a low freezing point (−54° C.).⁵ This can translate to retention of fluidity and ion mobility over a wider temperature range in the resulting solid-liquid nanocomposites. Preliminary low-temperature ion conductivity and NMR diffusion studies on the cross-linked Q_{II} phase 1/PC materials down to −50° C. have provided support for this supposition. Preliminary ion conductivity measurements of a Q_{II}-phase 1-PC film cooled to ca. −35° C. showed a conductivity of ca. 10⁻⁵ S cm⁻¹, whereas solvent-free PEO/Li salt complexes have been reported to typically show only ca. 10⁻⁸ S cm⁻¹ at −40° C.³ Initial NMR studies have also shown that the PC solvent molecules in the cross-linked Q_{II} 1/PC material are still mobile and liquid-like down to −50° C. (2) The high capillary forces inside the ionic nanopores of these LLC polyelectrolyte networks prevents facile evaporative or leaching loss of the solvent from the composite, as seen previously in cross-linked O-phase materials formed with water.¹⁵ Liquid electrolyte evaporative loss and leaching from gelled polymer electrolytes are common problems with current Li battery gelled electrolyte materials.³ (3) The extremely small diameter liquid transport channels in this LLC composite material may also afford suppression of Li metal dendrite growth during battery charging, which is also a common efficiency problem in conventional polymer-based electrolytes.³ Usually, gelled polymer electrolyte materials with large, interconnected, macroscopic liquid electrolyte pore pathways are very susceptible to this problem,³ but the growth of Li metal dendrites through nanochannels 1-10 nm in diameter, should be much more difficult/slower. It is noted that monomer 1 is an exemplary monomer of the invention which can be practiced with additional monomers and mixtures of monomers as described herein.

In various aspects of the invention, the polymer electrolyte comprises cross-linked polymerizable LLC surfactants and a solution comprising a non-aqueous solvent and a dissolved lithium salt, wherein the polymerizable LLC surfactants may be ionic, non-ionic, acidic or combinations thereof. The polymer electrolyte typically comprises a nanostructured matrix formed of the polymerized LLC surfactants, the matrix comprising nanochannels containing the solvent and Li salt ions. The solution comprising the solvent and the dissolved lithium salt may also be referred to as the liquid electrolyte and the solvent referred to as the (liquid) electrolyte solvent. In different embodiments, the polymer electrolyte may be formed by polymerization of LLC surfactants which form the cubic phase, the bi-continuous cubic phase, the hexagonal phase, the inverted hexagonal phase, the lamellar phase or some combination of phases in the solution comprising the non-aqueous solvent and the dissolved lithium salt. In an embodiment, the LLC surfactants form the inverted cubic (Q_{II}) phase in the solution comprising the Li salt ions. In different embodiments, the effective pore size is from about 4 Angstroms to about 15 Angstroms, from 4 Angstroms to 25 Angstroms, and from 3 Angstroms to 100 Angstroms. In another embodiment, a cross-linking agent may be added to the polymerizable surfactant to increase the cross-linking density and/or mechanical properties of the polymer electrolyte. In an embodiment the polymer electrolyte may comprise the cubic phase, the bi-continuous cubic phase, the hexagonal phase, the inverted hexagonal phase, the lamellar phase or some combination of phases.

In another embodiment of the invention, the polymer electrolyte comprises cross-linked polymerizable LLC salt surfactants and a solution comprising a non-aqueous solvent and a dissolved lithium salt. In this embodiment, the polymer electrolyte comprises a nanostructured matrix formed of the polymerized LLC salt surfactants, the matrix comprising nanochannels containing the solvent and Li salt ions. In different embodiments, the polymer electrolyte may be formed by polymerization of LLC salt surfactants which form the cubic phase, the bi-continuous cubic phase, the hexagonal phase, the inverted hexagonal phase, the lamellar phase or some combination of phases in the solution comprising the non-aqueous solvent and the dissolved lithium salt. In an embodiment, the LLC salt surfactants form the inverted cubic (Q_{II}) phase in the solution comprising the Li salt ions. In different embodiments, the effective pore size is from about 4 Angstroms to about 15 Angstroms, from 4 Angstroms to 25 Angstroms, and from 3 Angstroms to 100 Angstroms. In another embodiment, a cross-linking agent may be added to the polymerizable salt surfactant to increase the cross-linking density and/or mechanical properties of the polymer electrolyte. In an embodiment the polymer electrolyte may comprise the cubic phase, the bi-continuous cubic phase, the hexagonal phase, the inverted hexagonal phase, the lamellar phase or some combination of phases.

In an embodiment, the cross-linkable LLC salt surfactant monomer is described by the following general structure:

[(X)R]ₙL(An)ₓ⁻M⁺

where:
X is any suitable polymerizable/cross-linkable functional group;
R is any suitable tail group;
n is an integer signifying the number of tail groups;
An is a suitable anionic headgroup;
x is an integer signifying the number of anionic groups;
L is a linking moiety, typically an organic diradical, such as an optionally substituted alkenylene or an arylene, that connects the one or more tail groups to the anion head group; and
M⁺ is any suitable cation, particularly Li⁺.

A monomer can contain a plurality (x) of anionic headgroups (An). An may be a monovalent anion, however, as noted below each An may contain one or more anions and in addition the specific anionic groups therein (e.g., —SO₃) may be multivalent, e.g., mono-, di- or tri-valent, for example. M⁺ is indicated to be monovalent and for applications described herein is Li⁺. The number of monovalent cations needed to form a given salt depends upon the relative valences of the ions. For example, one Li⁺ will be needed to form a neutral salt with a —SO₃⁻ anion and two Li⁺ will be needed to form a neutral salt with a —PO₃²⁻ anion. The number of cations also depends upon the number of anions in a headgroup. For example, for a headgroup carrying two monovalent anions, two Li⁺ cations are needed to form the salt. It will be appreciated by one of ordinary skill in the art that the number of cations in formulas herein is that which is needed to form a charge neutral salt.

The anionic headgroup of the monomer, An comprises one or more anions, which can be selected from sulfonates, fluorinated sulfonates, aromatic sulfonates, and substituted aromatic sulfonates. The headgroup may also contain an organic group to which the one or more anions are bonded as substituents. Thus a given An may contain a plurality of anions. If this is the case, the multiple anions in a headgroup may be the same or different, but are preferably the same. The headgroup can simply be an alkyl chain (alkenylene) to which one or more anions or anionic groups are bonded, an aromatic ring (phenyl, benzyl or naphthyl) to which one or more anions or anionic groups are attached or a heterocyclic or heteroaromatic ring (in such species the one or more anions or anionic groups are substituted at one or more carbons in the hetero ring or rings or substituted on an alky group substituted on the ring or rings). In particular embodiments, the anionic headgroup comprises a benzene sulfonate derivative wherein the benzene ring may carry one or more substituents. Examples of benzene sulfonate derivatives include, without limitation, nitro aniline sulfonate, amino aniline sulfonate, methyl aniline sulfonate, amino phenol sulfonate, metanilate, or sulfanilate. Further examples of substituents that may be incorporated into the benzene sulfonate derivative include without limitation, one or more alkyl groups, alkoxy groups, halogens, carbonyls, acyl groups (e.g., acetyl groups) or hydroxyls. The number of An groups, x, may only be limited by the number of available linking site on the L group. However, x generally may equal 1. In an embodiment, x is equal to 1. In other embodiments, the L group may contain a ring structure, e.g, an alicyclic, aromatic or heteroaromatic ring, which carries multiple attachment sites for anions or anionic groups. In specific embodiments, the number of anions in the monomer surfactant is 1, 2, 3, 4, 5 or 6. More specifically, the number of anions in the monomer surfactant is 1, 2, 3 or 4.

The anionic head group may also comprise any suitable fluorinated head groups. Examples of fluorinated head groups include without limitation, amino difluorocarboxylates, and fluorinated alkyl sulfonates. Without being limited by theory, using polymerizable surfactants with a sulfonated or fluorinated head group may result in a sufficiently higher degree of cation dissociation due to the electron withdrawing nature of the aromatic ring resulting in higher room temperature conductivity. In specific embodiments, the ionic cross-linkable monomer of the invention is not fluorinated.

The linking moiety, L, may comprise any appropriate group or molecule that is capable of connecting An with the one or more tail groups. L is typically an organic, hydrocarbon species, particularly alkylene chains, cycloalkylene species, arylene species, such as 1,4-phenylene, or 1,3-phenylene, or naphthylene, heterocylene, or heteroarylene species, each of which is optionally substituted. In some embodiments, L an alkylene (—CH₂—)ₙ where n is an integer and typically is 1-12, 1-6, 1-4 or 1 or 2. In other embodiments, L may comprise an ether linkage which may contain 1 to 6 oxygens, i.e., —CH₂—O—CH₂—, —(CH₂)ₙ—O—(CH₂)ₘ—, —(CH₂)ₙ—(—O—(CH₂)ₚ—O—)—(CH₂)ₘ—, where n, m and p are integers which independently range from 1-12 and wherein the sum of n+m+p is preferably 1-14 or 1-10 and in specific embodiments, p is 2, 3 or 4 and m is 1, 2, 3 or 4. Linear divalent linkers can generically be described as having the formula —(CH₂)ₓ— where x is an integer from 1 to 20, where, when x is greater than one, one to x/2 non-neighboring —CH₂— groups can be replaced with —O—, —CO—, —CO—NR′—, —O—CO—, —CO—O—, —NR′—CO—, or —NR′—CO—NR′—, and in specific embodiment, L of this formula is an alkylene, the linker is L which contains 1-3 oxygens, the linker contains one of —CO—, —CO—NR′—, —O—CO—, —CO—O—, —NR′—CO—, or —NR′—CO—NR′—, the linker contains one or two of —CO—, —CO—NR′—, —O—CO—, —CO—O—, —NR′—CO—. In specific embodiments, the linker of this formula ranges in length from 1-10 atoms.

In specific embodiments, L groups can be cyclic and contain one or more alicycic or aromatic rings. Specific linkers include phenylene and naphthylene, and biphenylene which may be substituted with one or more substituents including generally electron withdrawing groups among others, and more specifically alkyl, alkoxy, halogen, nitro, and cyano.

R may comprise any suitable hydrophobic tail group. In an embodiment, R may comprise a hydrocarbon chain containing between 1 to 30 carbon atoms, alternatively between 5 to 20 carbons, alternatively between 8 to 15 carbons. R may also comprise an unsaturated hydrocarbon chain containing one or more double bonds (alkenyl groups), i.e., (—CH═CH—). In an embodiment R may comprise one or more ether portions such as —CH₂—O—CH₂— bonded into an alkylene chain. R may optionally comprise various combinations of heteroatoms and functional groups such as ether linkages (O), amine linkages (—NH—), amide linkages (—NH—CO—), carbonyl linkages (—CO—), ester (—OCO—) linkages and combinations thereof. In additional embodiments, the LLC salt surfactant may comprise one or more RX groups. In other words, n may equal 1, 2, 3, etc. Typically, the LLC salt surfactant may comprise three RX tail groups. In other embodiments, the polymerizable surfactant may comprise two tail groups forming a “Gemini” surfactant. However, the number of tail groups, RX, may only be limited by the number of linkages available to L, the linking moiety. In certain embodiments with more than one tail group, each R group may comprise different chain lengths.

While M most generally can comprise any cation capable of forming a salt, for applications described herein M is Li⁺.

X may comprise any polymerizable functional group. As defined herein, polymerizable functional group means any chemical moiety that is capable of being cross-linked or covalently bonded with another chemical moiety with some form of initiation. In particular, polymerizable groups include those which can be polymerized via chain addition polymerization and more specifically by free radical chain addition polymerization. Examples of appropriate functional groups include without limitation, acrylate groups, methacrylate groups, dienes, alkynyl groups, allyl groups, vinyl groups, acrylamides, hydroxyl groups, fumarate groups, styrene groups, terminal olefins, isocyanate groups, acrylamide groups or combinations thereof. Additional, more specific polymerizable groups PG are illustrated herein below. In embodiments where the LLC monomer comprises more than one tail group, R, the polymerizable functional group, X, may be the same for each tail group. In other embodiments, X may be different for each tail group, R. While in preferred embodiments, as illustrated in the above formula, each tail group comprises a polymerizable group, in embodiments herein, at least one of the R tailgroups comprises a polymerizable group.

In another embodiment, the LLC surfactant is described such that X is either an acrylate, methacrylate or diene polymerizable group; R is an alkyl chain containing from 8 to 20 carbon atoms, n is 1 to 3 (1-3 tails), L is an aromatic group, an organic group containing 6 or fewer carbon atoms, or an ethyl group containing 2 carbon atoms; An is an aromatic sulfonate group, or an alkyl sulfonate group; x is one (anionic group); and M⁺ is a lithium cation. In an embodiment, n is 3 tails. In another embodiment, L is an aromatic ring that connects the one or more tail groups to the anion head group.

In an embodiment, M⁺ is a mixture of cations that include lithium cations, and may contain other cations such as sodium, potassium, or others. A portion of M⁺ may also be protons. In embodiments herein for application to lithium batteries, M⁺ is Li⁺.

In another embodiment of the invention, the polymerizable LLC surfactant may be a polymerizable LLC acidic surfactant. The polymerizable acidic LLC surfactant may comprise any suitable polymerizable functional group, X, any suitable tail group, R, a linking moiety, L, that connects the one or more tail groups to the anion head group; a headgroup, An, that may comprise any suitable acidic group. The number of tail groups RX may be given by the integer n. The acidic group may be a sulfonic acid, an aromatic sulfonic acid, an alkyl sulfonic acid, or other acid. For instance where An may be any acidic group, M⁺ is a proton. X, R, n and L may be as described above.

In another embodiment of the invention, the polymerizable LLC surfactant may be a polymerizable non-ionic LLC surfactant. In an embodiment, the polymerizable LLC surfactant may be described by the following general structure, [(X)R]ₙL(neutral HG) where:

X may be any suitable polymerizable functional group;

R may be any suitable tail group;

n may be an integer signifying the number of tail groups;

and “neutral HG” may be any suitable neutral head group.

The neutral head group may be an oligomeric segment of polyethylene glycol (for example ethylene glycol, diethylene glycol, triethylene glycol, tetra ethylene glycol, other oligomer), or a group containing hydroxyls. The neutral head group may be an oligomeric polyproplylene glycol (for example propylene glycol, dipropylene glycol, tripropylene glycol, tetra propylene glycol, or other oligomer).

In an embodiment, X, R, n and L may be as described above. In another embodiment the non-ionic LLC surfactant may be described such that X may be either an acrylate, methacrylate or diene polymerizable group; R may be an alkyl chain containing from 8 to 20 carbon atoms, n may be from 1 to 3 tails, and the neutral head group may be an ethylene glycol, a propylene glycol oligomer with four or fewer repeat units, a linear or branched group containing 1 to 4 hydroxyl units, or a cyclic ether or cyclic crown ether.

In an additional embodiment, the ionic LLC polymerizable surfactant may be described by the following general structure;

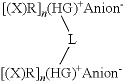

where the terms X, R, n, and L are previously defined. “HG” represents a headgroup that may be cationic, and may be a phosphonium group, an imidazolium, or other cationic group. These compounds are commonly referred to as “Gemini” surfactants due to the presence of two head groups. “Anion⁻” can be any suitable anion group.

In an embodiment, X, R, n and L may be as described above. In another embodiment, the LLC salt surfactant may be described as the Gemini surfactant wherein X may be either an acrylate, methacrylate or diene polymerizable group; R may be an alkyl chain containing from 8 to 20 carbon atoms, n may be 1 tail on each head group; the cationic headgroup may be either an phosphonium or imidazolium group; and the Anion⁻ group may be a chloride, bromide, trifluoromethane sulfonate, para-toluene sulfonate or perchlorate group. The Anion⁻ group may be the same or different from the anion group used to form the liquid electrolyte. Several imidazolium-based polymerizable LLC surfactants are described in U.S. Patent Application Publication US2008/0029735 A1 to Gin et al. which is incorporated by reference herein in its entirety for its description of exemplary polymerizable LLC surfactants.

In a further embodiment of the invention, mixtures of LLC surfactants may be used to form a lyotropic phase. In different embodiments, the polymer electrolyte may be formed from mixtures ionic LLC surfactants, acidic LLC surfactants, non-ionic LLC surfactants, and combinations thereof. In a more specific embodiment, the LLC surfactant monomer has the formula:

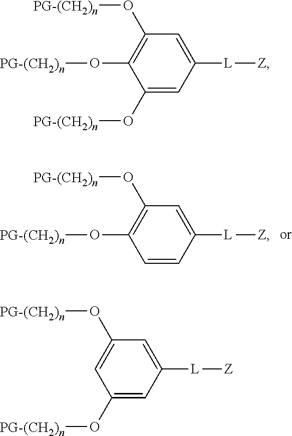

where
each n, independently, is an integer from 6-14, and in preferred embodiments all n in a given monomer are the same. In specific embodiments, n is 8-12 or n is 10-12;
L is a linker as discussed generally above;
Z is a Li-salt-containing ionic headgroup which preferably comprises a fairly non-basic anionic group, such as sulfonate-(SO₃⁻) or phosphonate (—PO₃²⁻), and where carboxylates (—CO₂⁻) are less preferred; and
PG is a chain-addition polymerizable group, polymerization/cross-linking of which can, for example, be initiated by radicals, anions or cations.

More specifically, PG is an activated olefin (i.e., activated for polymerization) and can in more specific embodiments be selected from:

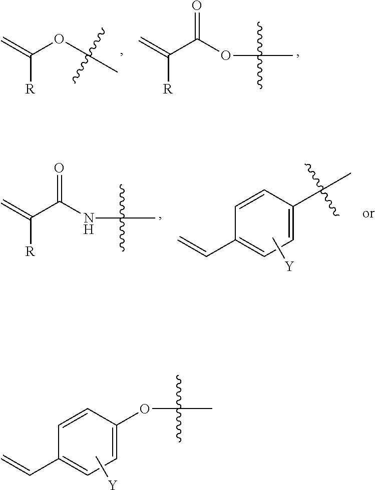

where R is hydrogen or an alkyl group which is optionally substituted with one or more substituents that do not interfere with polymerization and Y represents hydrogen or hydrogen and 1 to 4 non-hydrogen substituents or preferably hydrogen and 1-2 non-hydrogen substituents. Y are substituents that do not interfere with polymerization. Exemplary R are alkyl of 1-3 carbon atoms. Exemplary Y are halogen, e.g., F or Cl, alkyl groups (e.g., alkyl with 1-3 carbon atoms), alkoxy (e.g., with 1 to 3 carbon atoms).

In yet more specific embodiments PG is selected from:

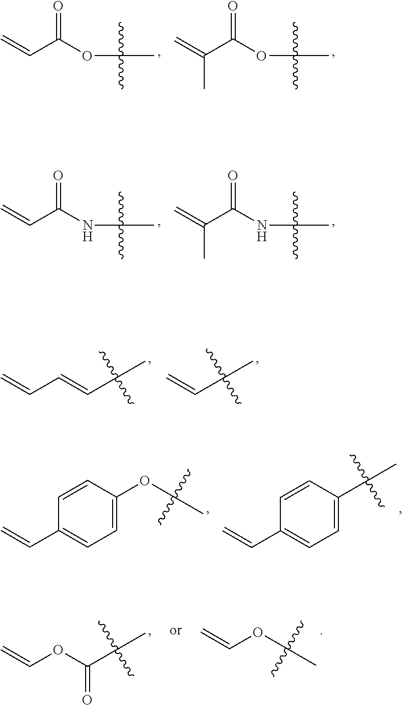

The headgroup Z comprises one or more anions (or salts thereof) and an headgroup linker which can be an alkylene, e.g., —(CH₂)ₚ— where p is an integer 1-6, preferably 1-3; an arylene, particularly a phenylene or a naphthylene. Alkylene and arylene linker moieties, in addition to substitution with the anionic group, are also optionally substituted with one or more non-hydrogen substituents, for example, with one or more alkyl, halogen, —NO₂, or —CN groups. Preferred alkylene-linked headgroups are —(CH₂)ₚ—SO₃⁻ Li⁺ and —(CH₂)ₚ—PO₃⁻ 2Li⁺, where p is an integer from 1 to 6 or 1-3 or 2. Another useful alkylene-linked headgroup is: —C(CH₃)₂—CH₂—SO₃ and the lithium salt thereof.

Preferred headgroups include:

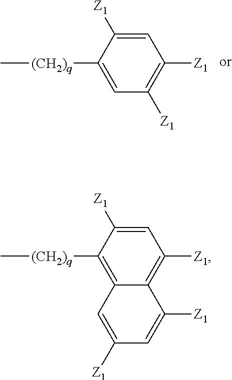

where q is 0 or an integer ranging from 1-6 or 1-3 or q is 0 or 1 and each Z₁, independently, is an anion (or lithium salt thereof), a hydrogen or a non-hydrogen substituent. In specific embodiments, 1, 2 3 or 4 of Z₁ are anionic groups (or lithium salts thereof).

Specific headgroup structures include among others:

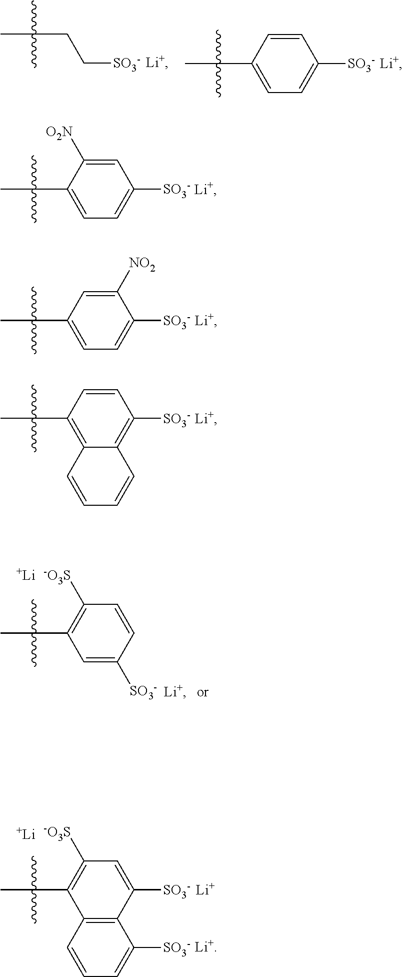

In a specific embodiment, the cross-linkable ionic monomer has the formula:

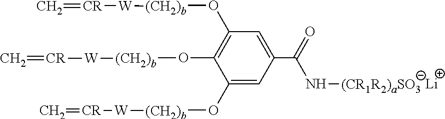

where a and b are integers, where a is 1 to 6 and preferably 1 or 2, and each b ranges from 6-14 and preferably each b is the same and preferred b are 10-12;
R is hydrogen or an alkyl group, particularly an alkyl group having 1-3 carbon atoms;

### W is —O—CO—, —CO—O—, —CO—NH—, —O—, —C₆H₄—, or —C₆H₄—O—;

each R₁ and R₂ is hydrogen or an alkyl group having 1-3 carbon atoms, wherein R₁ and R₂ together can represent 2-4 alkyl groups.

In specific embodiments, L is an alkylene linker, having 1-10 carbon atoms, in which one or more of the carbons on L are substituted with an amide (—C(O)—NH—), an oxygen (—O—) or an ester (—C(O)—O—) group. In specific embodiments, the linker is —C(O)—NH—, —O—, or —C(O)—O—. In specific embodiments, the cross-linkable ionic monomer is a monomer other than LiAMPS:

CH₂═CH—CO—NH—C(CH₃)₂—CH—SO₃^{β}Li^{⊕}.

The polymer electrolyte of the invention comprises a polymer electrolyte comprising a polymer matrix which is cross-linked and a liquid electrolyte contained within the polymer matrix. The term “contained” is used to refer to the presence of the liquid electrolyte in the polymer electrolyte. The liquid electrolyte is believed to be retained in the polymer matrix substantially as a liquid phase, but the liquid electrolyte (solvent plus free salt) does not leak out of the material. It will be appreciated that some low level of liquid electrolyte leakage may be accommodated without affecting performance and without any substantial loss of functionality.

The term organic group, refers generally to hydrocarbon based species which may contains various heteroatoms and functional groups and generally includes saturated and unsaturated, linear, branched and cyclic species (alkyl, alkenyl and alkynyl groups) as well as aromatic (aryl and heteroaryl) species. The specification refers to a number of specific chemical groups my name and or structure. The terms used are intended to have their broadest meaning in the art unless otherwise stated.

The term “alkyl” refers to a monoradical of a branched or unbranched (straight-chain or linear) saturated hydrocarbon and to cycloalkyl groups having one or more rings. Unless otherwise indicated preferred alkyl groups have 1 to 30 carbon atoms and more preferred are those that contain 1-22 carbon atoms. Short alkyl groups are those having 1 to 6 carbon atoms including methyl, ethyl, propyl, butyl, pentyl and hexyl groups, including all isomers thereof. Long alkyl groups are those having 8-30 carbon atoms and preferably those having 12-22 carbon atoms as well as those having 12-20 and those having 16-18 carbon atoms. The term “cycloalkyl” refers to cyclic alkyl groups having preferably 3 to 30 carbon atoms having a single cyclic ring or multiple condensed rings. Cycloalkyl groups include, by way of example, single ring structures such as cyclopropyl, cyclobutyl, cyclopentyl, cyclohexyl, cyclooctyl, and the like, or multiple ring structures such as adamantanyl, and the like. Unless otherwise indicated alkyl groups including cycloalkyl groups are optionally substituted as defined below.

The term “alkenyl” refers to a monoradical of a branched or unbranched unsaturated hydrocarbon group having one or more double bonds and to cycloalkenyl group having one or more rings wherein at least one ring contains a double bond. Unless otherwise indicated preferred alkenyl groups have 1 to 30 carbon atoms and more preferred are those that contain 1-22 carbon atoms. Alkenyl groups may contain one or more double bonds (C═C) which may be conjugated or unconjugated. Preferred alkenyl groups are those having 1 or 2 double bonds and include omega-alkenyl groups. Short alkenyl groups are those having 2 to 6 carbon atoms including ethylene (vinyl), propylene, butylene, pentylene and hexylene groups including all isomers thereof. Long alkenyl groups are those having 8-30 carbon atoms and preferably those having 12-22 carbon atoms as well as those having 12-20 carbon atoms and those having 16-18 carbon atoms. The term “cycloalkenyl” refers to cyclic alkenyl groups of from 3 to 30 carbon atoms having a single cyclic ring or multiple condensed rings in which at least one ring contains a double bond (C═C). Cycloalkenyl groups include, by way of example, single ring structures (monocyclic) such as cyclopropenyl, cyclobutenyl, cyclopentenyl, cyclohexenyl, cyclooctenyl, cylcooctadienyl and cyclooctatrienyl as well as multiple ring structures. Unless otherwise indicated alkyl groups including cycloalkenyl groups are optionally substituted as defined below.

The term “alkynyl” refers to a monoradical of an unsaturated hydrocarbon having one or more triple bonds (C≡C). Unless otherwise indicated preferred alkyl groups have 1 to 30 carbon atoms and more preferred are those that contain 1-22 carbon atoms. Alkynyl groups include ethynyl, propargyl, and the like. Short alkynyl groups are those having 2 to 6 carbon atoms, including all isomers thereof. Long alkynyl groups are those having 8-22 carbon atoms and preferably those having 12-22 carbon atoms as well as those having 12-20 carbon atoms and those having 16-18 carbon atoms. The term “cycloalkynyl” refers to cyclic alkynyl groups of from 3 to 30 carbon atoms having a single cyclic ring or multiple condensed rings in which at least one ring contains a triple bond (C≡C). Unless otherwise indicated alkynyl groups including cycloalkynyl groups are optionally substituted as defined below.

The term “alicyclyl” generically refers to a monoradical that contains a carbon ring which may be a saturated ring (e.g., cyclohexyl) or unsaturated (e.g., cyclohexenyl) but is not aromatic (e.g., the term does not refer to aryl groups). Ring structures have three or more carbon atoms and typically have 3-10 carbon atoms. As indicated above for cycloalkane, cycloalkenes and cycloakynes, alicyclic radical can contain one ring or multiple rings (bicyclic, tricyclic etc.).

The term “aryl” refers to a monoradical containing at least one aromatic ring. The radical is formally derived by removing a H from a ring carbon. Aryl groups contain one or more rings at least one of which is aromatic. Rings of aryl groups may be linked by a single bond or a linker group or may be fused. Exemplary aryl groups include phenyl, biphenyl and naphthyl groups. Aryl groups include those having from 6 to 30 carbon atoms and those containing 6-12 carbon atoms. Unless otherwise noted aryl groups are optionally substituted as described herein.

The term “heterocyclyl” generically refers to a monoradical that contains at least one ring of atoms (typically having 5-8 ring members, which may be a saturated, unsaturated or aromatic ring wherein one or more carbons of the ring are replaced with a heteroatom (a non-carbon atom) To satisfy valence the heteroatom may be bonded to H or a substituent groups. Ring carbons may be replaced with —O—, —S—, —NR—, —N═, —PR—, or —POR among others.

The term “heteroaryl” refers to a group that contains at least one aromatic ring in which one or more of the ring carbons is replaced with a heteroatom (non-carbon atom). To satisfy valence the heteroatom may be bonded to H or a substituent groups. Ring carbons may be replaced with —O—, —S—, —NR—, —N═, —PR—, or —POR among others, where R is an alkyl, aryl, heterocyclyl or heteroaryl group. Heteroaryl groups may include one or more aryl groups (carbon aromatic rings) heteroaromatic and aryl rings of the heteroaryl group may be linked by a single bond or a linker group or may be fused. Heteroaryl groups include those having aromatic rings with 5 or 6 ring atoms of which 1-3 ring atoms are heteroatoms. Preferred heteroatoms are —O—, —S—, —NR— and —N═. Heteroaryl groups include those containing 6-12 carbon atoms. Unless otherwise noted heteroaryl groups are optionally substituted as described herein.

Alkoxy or alkoxyl refers to an alkyl group, such as from 1 to 8 carbon atoms, of a straight, branched, or cyclic configuration, or a combination thereof, attached to the parent structure through an oxygen (i.e., the group alkyl-O—). Examples include methoxy-, ethoxy-, propoxy-, isopropoxy-, cyclopropyloxy-, cyclohexyloxy- and the like. Lower-alkoxy refers to alkoxy groups containing one to three carbons.

The term “alkylene” refers to a diradical of a branched or unbranched saturated hydrocarbon chain, which unless otherwise indicated can have 1 to 10 carbon atoms, or 1-6 carbon atoms, or 2-4 carbon atoms. This term is exemplified by groups such as methylene (—CH₂—), ethylene (—CH₂CH₂—), more generally —(CH₂)ₙ—, where n is 1-10 or more preferably 1-6 or n is 2, 3 or 4. Alkylene groups may be branched, e.g, by substitution with alkyl group substituents. Alkylene groups may be optionally substituted as described herein. Alkylene groups may have up to two non-hydrogen substituents per carbon atoms. Preferred substituted alkylene groups have 1, 2, 3 or 4 non-hydrogen substituents. Hydroxy-substituted alkylene groups are those substituted with one or more OH groups. Alkylene groups may also be substituted with alkyl, alkoxy and halogen.

The term “alkoxyalkylene” refers to a diradical of a branched or unbranched saturated hydrocarbon chain in which one or more —CH₂— groups are replaced with —O—, which unless otherwise indicated can have 1 to 10 carbon atoms, or 1-6 carbon atoms, or 2-4 carbon atoms. This term is synonymous with the term ether group and includes polyethers. This term is exemplified by groups such as —CH₂OCH₂—, —CH₂CH₂OCH₂CH₂—, —CH₂CH₂OCH₂CH₂OCH₂CH₂— and more generally —[(CR″₂)ₐ—O—]_{b}—(CR″₂)_{c}, where R″ is hydrogen or alkyl, a is 1-10, b is 1-6 and c is 1-10 or more preferably a and c are 1-4 and b is 1-3. Alkoxyalkylene groups may be branched, e.g., by substitution with alkyl group substituents. The term “thioalkoxyalkylene” refers to a diradical of a branched or unbranched saturated hydrocarbon chain in which one or more —CH₂— groups are replaced with —S—, which unless otherwise indicated can have 1 to 10 carbon atoms, or 1-6 carbon atoms, or 2-4 carbon atoms

Alkyl, alkenyl, alkynyl, aryl, heterocyclyl and heterocyclyl groups may be substituted or unsubstituted. These groups may be optionally substituted as described herein and may contain non-hydrogen substituents dependent upon the number of carbon atoms in the group and the degree of unsaturation of the group. Unless otherwise indicated substituted alkyl, alkenyl alkynyl aryl, heterocyclyl and heterocyclyl groups preferably contain 1-10, and more preferably 1-6, and more preferably 1, 2 or 3 non-hydrogen substituents.

Optional substitution refers to substitution with one or more of the following functional groups: halogens, hydroxyl, alkyl, alkoxy, aryl, aryloxy, nitro, cyano, amino, acyl (R—CO—), —CO—O—R, —CO—R, —CO—N(R)₂, —O—COR, and —NR—COR, where R is hydrogen, alkyl or aryl, for example), —SO², isocyano, thiocyano and combinations thereof and where optionally substitution includes substitution by any one of the listed groups or any combination of two of the listed groups. In specific embodiments, optional substitution particularly of aryl rings includes substitution by one or more electron withdrawing groups which term is defined as broadly as it is known and used in the art. For substitution of monomer herein, substituents are generally selected which do not interfere with polymerization or cross-linking.

As to any of the above groups which contain one or more substituents, it is understood, that such groups do not contain any substitution or substitution patterns which are sterically impractical and/or synthetically non-feasible. In addition, the compounds of this invention include all stereochemical isomers arising from the substitution of these compounds.

The compounds of this invention may contain one or more chiral centers. Accordingly, this invention is intended to include racemic mixtures, diasteromers, enantiomers and mixture enriched in one or more stereoisomer. The scope of the invention as described and claimed encompasses the racemic forms of the compounds as well as the individual enantiomers and non-racemic mixtures thereof.

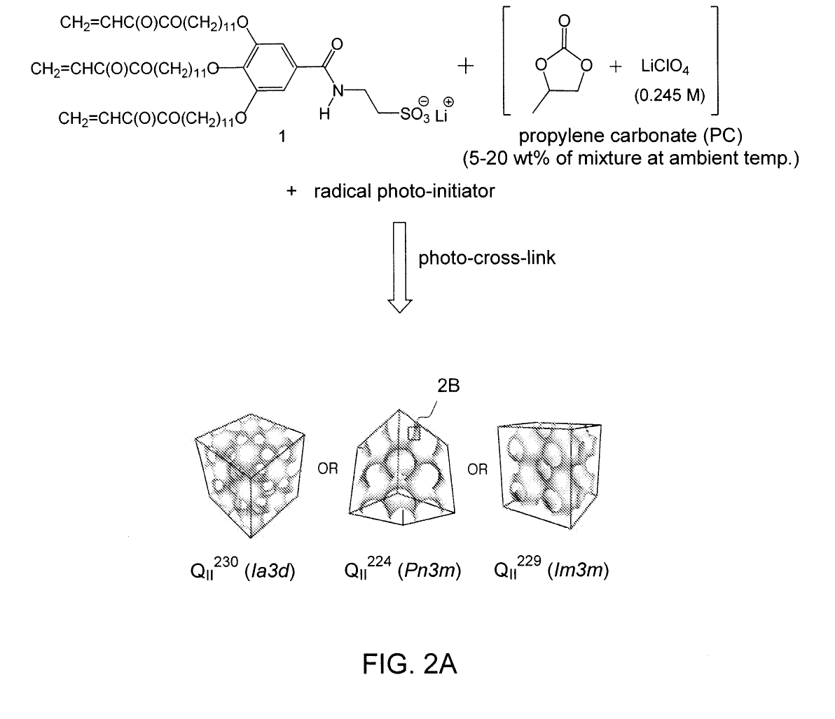

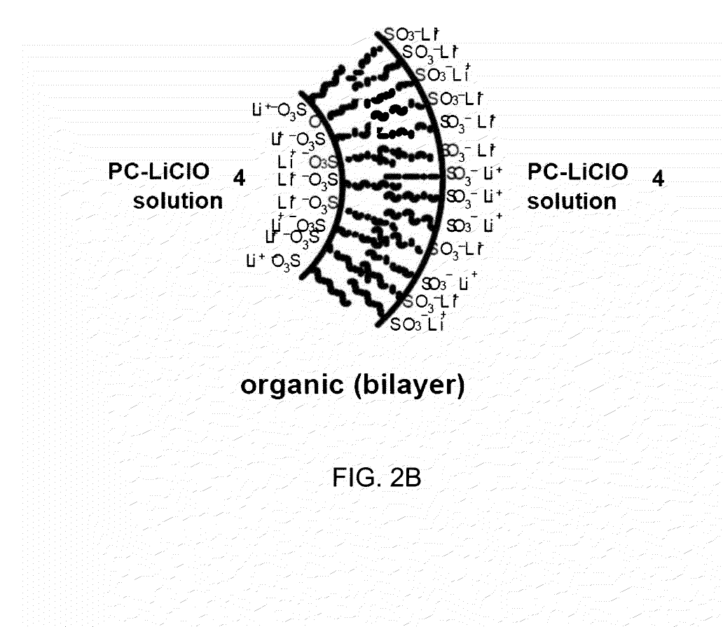

The polymer electrolyte of the invention comprises a liquid electrolyte which comprises an organic solvent and a free alkali metal salt, particularly a Li salt. The term free salt is used herein to refer to an alkali metal salt, particularly a lithium salt where the anion of the salt is not bonded to or cross-linked into the polymer matrix. The organic solvent is a solvent or mixture of solvents useful for liquid electrolytes. Organic carbonates, especially the cyclic carbonates such as PC and its homologues (ethylene carbonate, etc.), are widely regarded as being suitable liquid electrolytes for use in Li ion batteries because of their combination of high ion conductivity, good ion solvation properties, high chemical and electrochemical stability, broad liquid temperature range, and relatively low cost.⁵ The PC/Li salt solution-filled Q_{II}-phase polyelectrolyte networks shown in FIG. 2 can be prepared by combining and thoroughly mixing together an appropriate wt % of a suitable monomer of the invention, e.g., monomer 1, a solution of an organic solvent such as PC with a free Li salt such as M LiClO₄, and small amount of a commercial organic radical photo-initiator to cross-link the formed Q_{II} phase.

In one aspect of the invention, the electrolyte solvent comprises an organic carbonate. In an embodiment, the solvent is a cyclic carbonate. In an embodiment, the liquid electrolyte solvent in the pores of the polymer electrolyte may comprise propylene carbonate (PC) or a derivative thereof, ethylenecarbonate (EC) or a derivative thereof, diethylcarbonate (DEC) or a derivative thereof, dimethylcarbonate (DMC) or a derivative thereof or other carbonate solvent. In another embodiment, the liquid electrolyte solvent may comprise a cyclic ester. Cyclic esters known to the art include, but are not limited to, γ-butyrolactone (BL). The liquid electrolyte solvent may comprise any combination of carbonate solvents or other suitable lithium battery electrolyte solvents.

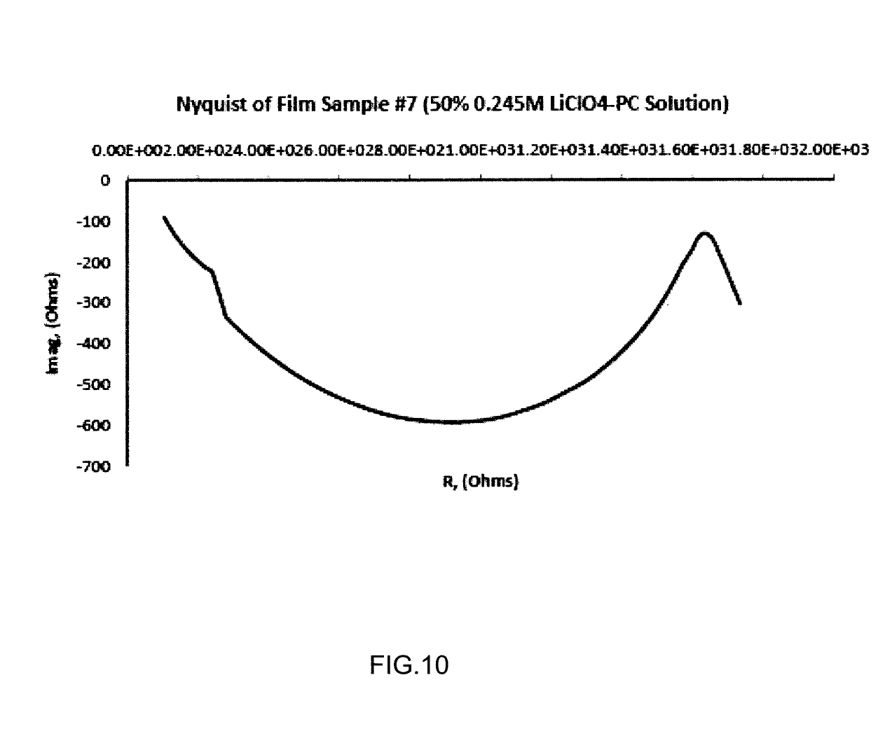

In an embodiment, the material compositions described herein (e.g., those employing a Li-salt-doped electrolyte solution for simultaneous LLC phase formation and facile Li ion conductivity) employ an atypical non-aqueous solvent for LLC phase formation. Only a handful of examples of non-aqueous (i.e., non-water-based, or water-free) LLC systems are known in the literature, in which the water traditionally required for LLC self-assembly is replaced by a polar organic solvent.¹⁶⁻³⁰ The number of examples in the literature of organic solvents that have been used successfully to induce LLC assembly, and that eventually fill the nanopores, is extremely limited because the solvents must be polar and hydrophilic enough to solvate and stabilize ionic and non-ionic hydrophilic headgroups. At the same time, they must not be very soluble in, or partition with, the hydrophobic tail regions of the LLC surfactants in order to generate the phase-separation behavior.³⁰ The polar organic solvents that have been used successfully as water substitutes for LLC assembly have included ethylene glycol,¹⁷⁻¹⁹ glycerol,²⁰⁻²¹ formamide,²¹⁻²⁶ N-methylformamide,²⁷⁻³⁰ dimethylformamide,²⁷⁻³⁰ and N-methylsydnone,²⁷⁻³⁰ (see FIG. 10), most of which are fairly water-miscible, erotic organic solvents, with the exception of N-methylsydnone. These polar, neutral organic solvents have been found to form a number of LLC phases (L, Q, H) with ionic and non-ionic surfactants and natural lipids in water-free compositions.¹⁷⁻³⁰

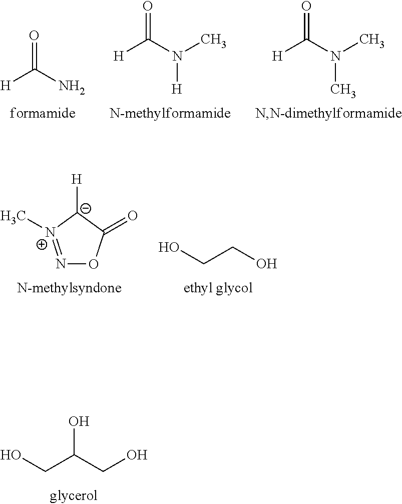

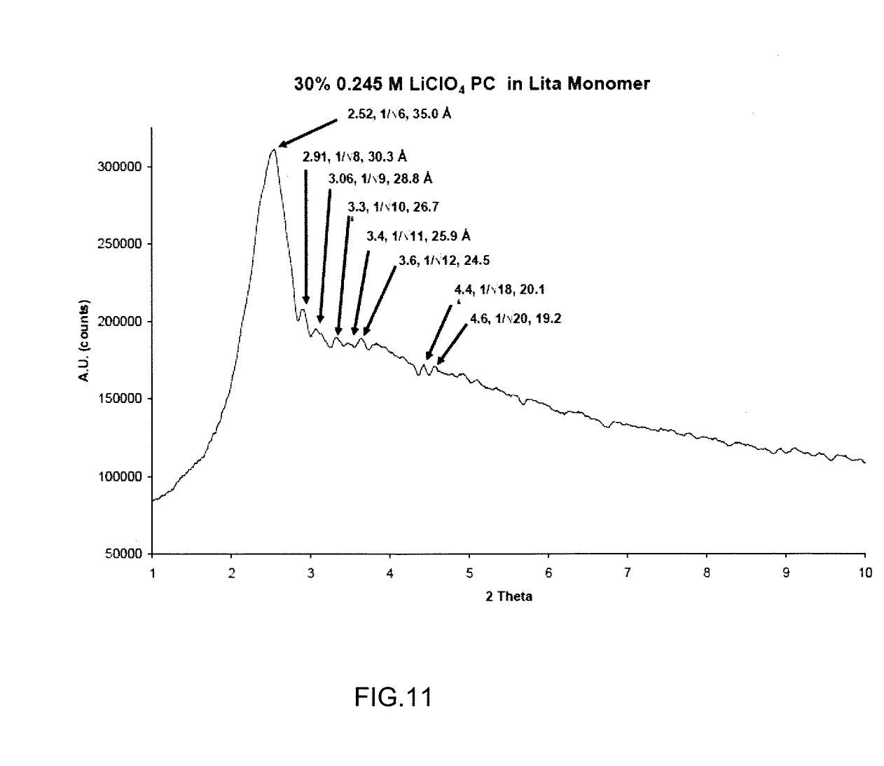

In addition to conventional organic solvents, room-temperature ionic liquids (RTILs) have also been recently used as water substitutes for LLC phase formation.³¹ RTILs are polar, molten organic salts under ambient conditions that are typically based on substituted imidazolium, phosphonium, ammonium, and related organic cations, complemented by a relatively non-basic and non-nucleophilic large anion.³² RTILs possess negligible vapor pressures; and as such, offer a non-volatile solvent medium for organization of LLCs. Since RTILs are very different from solvents like water, fundamental work has been concerned with understanding how small-molecule surfactants organize around and in RTILs.^{33,34} A number of RTIL-based LLC systems have been specifically designed to serve as anisotropic, ion-conducting nanocomposite materials. These include L phase materials formed by combining an RTIL with an LLC mesogen or imidazolium-based amphiphiles;³⁵ and hydroxyl-terminated fluorinated surfactants formed by mixing with imidazolium-based RTILs (FIG. 11).^{36,37} More recently, hydroxyl-terminated H_{II}-phase LLC systems formed around imidazolium-based RTILs have been reported as one-dimensional ion conducting materials.³⁸ Examples of ion-conductive LLC systems that form L (top two examples) and H_{II} phases (bottom example) with imidazolium-based RTILs as the polar liquid phase³⁶⁻³⁸ include:

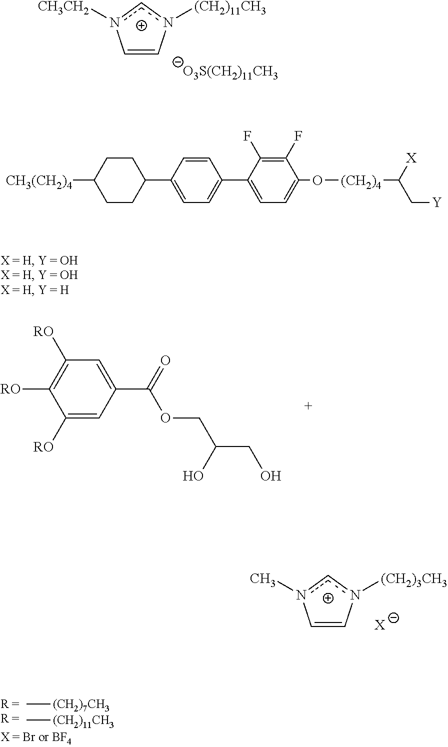

It should be noted that a number of research groups have described the use of other LC-based starting materials to make nanostructured, anisotropic, Li ion-conducting organic solids and polymers.²⁹⁻⁴¹ However most of these materials have been solvent-free LC systems (i.e., thermotropic LC systems), as opposed to the solvent-based LLC systems in the current disclosure.

In an embodiment of the invention, a nanoporous polymer electrolyte formed from polymerizable LLCs comprises at least one liquid-filled pore, the liquid comprising PC (or a similar liquid electrolyte solvent) containing at least one dissolved lithium salt. In an embodiment, the resulting composite material has a lithium ion conductivity greater than or equal to 10⁻⁴ S cm⁻¹. In another embodiment, the above composite electrolyte material has a lithium ion conductivity greater than or equal to 10⁻⁴ S cm⁻¹ at 23° C.

In an embodiment the salt dissolved in the liquid electrolyte comprises a lithium inorganic or a lithium organic salt. The salt may be selected from the group consisting of lithium chloride, lithium perchlorate, lithium para-toluene sulfonate, lithium trifluoromethanesulfonate, or a combination of at least two lithium salts. In another embodiment, the salt may be selected from the group consisting of LiClO₄, LiBF₄, LiPF₆, LiAsF₆, LiCF₃SO₃, LiN(CF₃SO₂)₂, LiC(CF₃SO₂)₃. In a further embodiment, the concentration of the lithium salt in the electrolyte solvent may range from about 0.05 Molar to about 2.0 Molar. In an embodiment of the invention the lithium salt concentration in the electrolyte solvent may range from about 0.1 to about 0.6 Molar. In another embodiment the lithium salt concentration can range from about 0.2 to about 0.3 Molar. In another embodiment, the concentration of the lithium salt may exceed 1 Molar.

In an embodiment the liquid electrolyte may comprise from about 1 weight % up to about 50 weight % of the total weight of the liquid electrolyte and the polymer electrolyte. In another embodiment the liquid electrolyte may comprise from about 2 weight % up to about 30 weight % of the total weight of the liquid electrolyte and the polymer electrolyte. In a further embodiment the liquid electrolyte may comprise from about 10 weight % up to about 20 weight % of the total weight of the liquid electrolyte and the polymer electrolyte.

In an embodiment, the polymerizable LLC surfactants may be crosslinked or polymerized into a variety of configurations to form a polymer electrolyte. The polymerizable surfactants may be crosslinked in a mold to form a desired shape. In another embodiment, the polymerizable surfactants may be cast as a film or coating on to any substrate and crosslinked to form the polymer electrolyte. Examples of suitable substrates include without limitation, steel, metal, polymer, composites, glass or combinations thereof. In another embodiment, the polymerizable surfactants may first fill or partially fill the pores of a macroporous polymer membrane support and then crosslinked to form the polymer electrolyte. The polymerizable surfactant may be dissolved in a suitable solvent (i.e., a casting solvent) to create a casting solution. Examples of suitable solvents include without limitation, acetone, tetrahydrofuran, acetonitrile, hexane, dichloromethane, ethyl acetate, toluene or chloroform. In an embodiment, the polymerizable LLC surfactants may be combined with the liquid electrolyte solvent and the liquid electrolyte may comprise a liquid with a vapor pressure lower than the casting solvent. Once cast on to the substrate, the casting solvent may be allowed to evaporate leaving the polymerizable surfactant film. When the casting solvent is evaporated, the liquid electrolyte solvent may remain in the polymer electrolyte film. The polymerizable surfactant may be cast by any means such as Wet-film (draw down), spraying, dip coating, or spin coating. The film may then be crosslinked by a variety of methods.

In particular embodiments, the polymerizable surfactant self-assemblies may be polymerized or crosslinked to form a solid, nanoporous polymer electrolyte with liquid-filled nanopores where the liquid contains a dissolved lithium salt. In some embodiments, the LLC monomer or polymerizable LLC surfactant may be photopolymerized by irradiation with light over a wide temperature range. The wavelength of light that may be used to crosslink the polymer electrolyte may range from about 200 nm to about 500 nm. In particular, UV light may be used. The photopolymerization may be facilitated by the addition of a photoinitiator. Examples of suitable photoinitiators include without limitation, benzophenone, isopropyl thioxanthone, benzyl dimethyl ketal, acylphosphine oxides, or combinations thereof. Alternatively, the polymerizable LLC monomers may be crosslinked using a chemical initiator. Examples of suitable chemical initiators include without limitation benzoyl peroxide, ammonium persulfate. In other embodiments, the LLC monomers may be crosslinked via thermal crosslinking, i.e., the application of heat. For thermal crosslinking a thermally activated initiator may be used such as 2-2′-azo-bis-isobutyrylnirile (AIBN). In other embodiments, the LLC monomers may be crosslinked via electron-beam irradiation.

In further embodiments, a crosslinking agent may be added to the polymerizable LLC surfactant to increase the crosslinking density and/or mechanical properties of the polymer electrolyte. However, it is to be understood that the polymerizable surfactant may be crosslinked without the need for either crosslinking agent or initiator. The crosslinking agent may comprise any compounds having polymerizable functional groups. Examples of suitable crosslinking agents include without limitation, ethylene glycol dimethacrylate derivatives, ethylene glycol diacrylate derivatives, methyelenebisacrylamide derivatives, divinylbenzene, or combinations thereof.

In a further embodiment, the polymerizable LLC may be crosslinked in situ on a battery anode or cathode material. The anode may be metallic lithium, a lithium composite, or a lithium compound. The anode may contain a form of lithium or lithium compound as part of its composition. The cathode may be a carbon material, or a compound that can contain lithium. The anode or cathode may be porous.

In an embodiment of this invention the liquid electrolyte filled-nanoporous polymer electrolyte comprises the electrolyte in a battery. In another embodiment of this invention the liquid electrolyte filled-nanoporous polymer electrolyte comprises the electrolyte in a lithium battery. The lithium battery can contain an anode and a cathode and involve chemical reactions where lithium ions are transported across the electrolyte.

Although the present invention and its advantages have been described in detail, it should be understood that various changes, substitutions and alterations may be made herein without departing from the spirit and scope of the invention as defined by the appended claims.

When a Markush group or other grouping is used herein, all individual members of the group and all combinations and subcombinations possible of the group are intended to be individually included in the disclosure. Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, are synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. In general the terms and phrases used herein have their art-recognized meaning, which can be found by reference to standard texts, journal references and contexts known to those skilled in the art.

All references throughout this application, for example patent documents including issued or granted patents or equivalents; patent application publications; and non-patent literature documents or other source material; are hereby incorporated by reference herein in their entireties, as though individually incorporated by reference. In the case that there is an inconsistency between the disclosure of an incorporated reference and the disclosure herein, the disclosure herein takes precedence.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

### REFERENCES

1. Megahed, S.; Ebner, W. J. Power Sources 1995, 54, 155.
2. Scrosati, B. Electrochim. Acta 2000, 45, 2461, and references therein.
3. Song, J. Y.; Wang, Y. Y.; Wan, C. C. J. Power Sources 1999, 77, 183, and references therein.
4. Kerr, J. B. Polymeric Electrolytes: An Overview; in Lithium Ion Batteries Science and Technology; Nazria, G.-A.; Pistoria, G., eds.; Kluwer Academic: Boston, 2004; Chapter 19.
5. Scrosati, B. Electrochim. Acta 2000, 45, 2461, and references therein; Nazri, M. Liquid Electrolytes: Some Theoretical and Practical Aspects; in Lithium Ion Batteries Science and Technology; Nazria, G.-A.; Pistoria, G., eds.; Kluwer Academic Boston, 2004; Chapter 17.
6. Handbook of Batteries, 3rd ed.;. Linden, D.; Reddy, T. B., Eds.; McGraw-Hill: New York, 2002; Chapter 34, p. 15.
7. Tiddy, G. J. T. Phys. Rep. 1980, 57, 1, and references therein.
8. Seddon, J. M. Biochim. Biophys. Acta 1990, 1031, 1, and references therein.
9. Luzzati, V.; Mustacchi, H.; Skoulios, A.; Husson, F. Acta Crystallogr. 1960, 13, 660.
10. http://www.gamry.com/App_Notes/EIS_Primer/EIS_Primer.htm
11. Impedance Spectroscopy; Theory, Experiment, and Applications, 2nd ed.; Barsoukov, E.; Macdonald, J. R., Eds.; Wiley Interscience: New York, 2005.
12. Electrochemical Impedance: Analysis and Interpretation; Scully, J. R.; Silverman, D. C.; Kendig, M. W. Eds; ASTM, 1993.
13. Bard, A. J.; Faulkner, L. R. Electrochemical Methods; Fundamentals and Applications; Wiley Interscience: New York, 2000.
14. Reiche, A.; et al. Polymer 2000, 41, 3821.
15. Lu, X.; Nguyen, V.; Zhou, M.; Zeng, X.; Jin, J.; Elliott, B. J.; Gin, D. L. Adv. Mater. 2006, 18, 3294.
16. For a review of amphiphile and LLC self-assembly in nonaqueous solvents, see: Ward, A. J.; du Reau, C. Surfactant Association in Nonaqueous Media; in Surface and Colloid Science; Matijevic, E.; Ed.; Plenum: New York, 1993; Chap. 4; p. 15.
17. Moucharafieh, N.; Friberg, S. E. Mol. Cryst. Liq. Cryst. 1979, 49, 231.
18. Larsen, D. W.; Friberg, S. E.; Christenson, H. J. Am. Chem. Soc. 1980, 102, 6565.
19. Backlund, S.; Bergenstähl, B.; Molander, O.; Wärnheim, T. J. Colloid. Interface. Sci. 1989, 131, 393.
20. Wärnheim, T.; Jönsson, A. J. Colloid Interface Sci. 1988, 125, 627.
21. Bergenstähl, B.; Stenius, P. J. Phys. Chem. 1987, 91, 5944.
22. Belmajdoub, A.; Marchall, J. P.; Canet, D.; Rico, I.; Lattes, A. New. J. Chem. 1987, 11, 415.
23. Auvray, X.; Anthore, R.; Petipas, C.; Pica, I.; Lattes, A. J. Phys. Chem. 1989, 93, 7458.
24. Auvray, X.; Perche, T.; Anthore, R.; Petipas, C.; Rico, I.; Lattes, A. Langmuir 1991, 7, 2385.
25. Auvray, X.; Abiyaala, M.; Duval, P.; Petipas, C.; Rico, I.; Lattes, A. Langmuir 1993, 9, 444.
26. Bergenstähl, B.; Jönsson, A.; Sjöblom, J.; Stenius, P.; Wärnheim, T. Prog. Colloid Polym. Sci. 1987, 74, 108.
27. Beesley, A. H.; Evans, D. F.; Laughlin, R. G. J. Phys. Chem. 1988, 92, 791.
28. Auvray, X.; Perche, T.; Anthore, R. Petipas, C.; Marti, M. J.; Rico, I.; Lattes, A. J. Phys. Chem. 1990, 94, 8604.
29. Auvray, X.; Perche, T.; Petipas, C.; Anthore, R. Langmuir 1992, 8, 2671.
30. Auvray, X.; Petipas, C.; Lattes, A.; Rico-Lattes, I. Colloids Surf. A: Physiochem. Engin. Aspects 1997, 123-124, 247.
31. For a recent comprehensive review of RTILs as non-aqueous solvents for amphiphile and LLC self-assembly, see: Greaves, T. L.; Drummond, C. J. Chem. Soc. Rev. 2008 37, 1709.
32. Welton, T. Chem. Rev. 1999, 99, 2071.
33. Greaves, T. L.; Weerawardena, A.; Fong, C.; Drummond, C. J. Langmuir 2007, 23, 402.
34. Wang, Z.; Liu, F.; Gao, Y.; Zhuang, W.; Xu, L.; Han, B.; Li, G.; Zhang, G. Langmuir 2005, 21, 4931.
35. Yoshio, M.; Kato, T.; Mukai, T.; Yoshizawa, M.; Ohno, H. Mol. Cryst. Liq. Cryst. 2004, 413, 2235.
36. Mukai, T.; Yoshio, M.; Kato, T.; Yoshizawa, M.; Ohno, H. Chem. Commun. 2005, 10, 1333.
37. Yoshio, M.; Mukai, T.; Kanie, K.; Yoshizawa, M.; Ohno, H.; Kato, T. Adv. Mater. 2002, 14, 351.
38. Shimura, H.; Yoshio, M.; Hoshino, K.; Mukai, Ohno, H.; Kato, T. J. Am. Chem. Soc. 2008, 130, 1759.
39. For recent reviews of thermotropic (i.e., solvent-free) LC-based Li⁺ ion-conducting materials, see: (a) T. Kato, N. Mizoshita, K. Kishimoto, Angew. Chem. Int. Ed. 2006, 45, 38, and references therein. (b) Funahashi, M.; Shimura, H.; Yoshio, M.; Kato, T. Struct. Bond. 2008, 128, 151.
40. Ichikawa, T.; Yoshio, M. Hamasaki, A.; Mukai, T.; Ohno, H.; Kato, T. J. Am. Chem. Soc. 2007, 129, 10662.
41. Yazaki, S.; Kamikawa, Y.; Yohio, M.; Hamasaki, A.; Mukai, T.; Ohno, H.; Kato, T. Chem. Lett. 2008 37, 538.

### The Examples

### Example 1

### Materials and General Procedures and Instrumentation

Methyl gallate (98%), acryloyl chloride (≧97%), 2-hydroxy-2-methylpropiophenone (97%), puriss-grade (99.995+) lithium hydroxide monohydrate, calcium carbonate (99%), taurine (i.e., 2-aminoethanesulfonic acid) (≧99%), potassium iodide (99%), propylene carbonate (≧99.7%), thionyl chloride (≧99), butylated hydroxytoluene (BHT), and Pestanal® water (≧99.99%) were all purchased from the Aldrich Chemical Company, and used as purchased unless otherwise stated. Mallinkrodt THF (ACS grade, stabilized), CH₂Cl₂ (ACS grade), and Burdick and Jackson High Purity Water were purchased from VWR Scientific. 11-Bromoundecanol (≧99%) was purchased from the Fluka Chemical Company. Pestanal® water is packaged under inert atmosphere and was opened and handled under an Ar atmosphere in a modified, dessicated, Scienceware glovebox. Fresh, sealed THF bottles were opened immediately before use for each reaction. CH₂Cl₂ was dried by passing through a bed of anhydrous alumina purchased from Zapp's in Gramercy, La., sparged with Ar prior to use, and stored under Ar. All solids, were dried and degassed in vacuo (<10 mtorr) while gently warming to 40° C. in an oil bath for 24 h, with the exception of 11-bromoundecanol which was dried and degassed in vacuo at ambient temperature only. All dried samples were stored in a desiccator when not in use. Powdering of crystalline samples was completed in a pre-heated (100° C.) mortar and pestle. Normal-phase column chromatography was performed using Sorbent Technologies 200×400 mesh premium Rf grade silica. Conventional Schlenk line techniques were used when performing all reactions to minimize water contamination, unless otherwise stated.

Instrumentation. ¹H NMR spectra were obtained using Varian Inova 500 (500 MHz) and Inova 400 (400 MHz) spectrometers. Chemical shifts are reported in ppm relative to residual non-deuterated solvent. Fourier-transform infrared spectroscopy (FT-IR) measurements were performed using a Mattson Satellite spectrometer, with the samples as thin films on Ge crystals. Powder X-ray diffraction (XRD) spectra were obtained with an Inel CPS 120 diffraction system using monochromatic Cu K_{α} radiation. XRD measurements on samples were all performed at ambient temperature (22±1° C.). Polarized optical microscopy (POM) studies was performed using a Leica DMRX P polarizing light microscope equipped with an Optronics or Qlmaging Micropublisher 3.3 RTV digital camera assembly. Mass spectrometry (MS) analysis was performed by the Central Analytical Facility in the Dept. of Chemistry and Biochemistry at the University of Colorado, Boulder. Elemental analyses were performed by Galbraith Laboratories, Knoxville, Tenn. The LLC mixtures were mixed using an IEC Centra-CL2 centrifuge. EIS/AC impedance measurements were conducted using an Agilent HP 4284A (20 Hz to 1 MHz) or an HP 4194A (100 Hz to 110 MHz) AC Impedance Analyzer connected to a stainless-steel and PTFE test cell that was made in-house at the University of Colorado Department of Chemical and Biological Engineering Machine Shop. The LLC film samples were photopolymerized between quartz glass slides at ambient temperature and under an inert Ar environment. A Spectroline Model XX-15A UVA (365 nm) lamp or an EXTECH UV-LED (365 nm) with DC power supply was used as the photopolymerization light source. UV light fluxes at the sample surface were measured using a Spectroline DRC-100× digital radiometer equipped with a DIX-365 UV-A sensor.

### Example 2

### Exemplary Synthesis of Monomer 1

Monomers useful in the invention can be prepared as exemplified for the synthesis of compound I as shown in Scheme 1.

3,4,5-Tris(11′-acryloyloxyundecyloxy)benzoic acid (2). This compound was synthesized as previously described in detail in the literature [Smith, R. C.; Fischer, W. M.; Gin, D. L. J. Am. Chem. Soc. 1997, 119, 4092-4093 (see: Supp. Info.)] Structural and chemical characterization (¹H NMR, ¹³C NMR, FTIR, and elemental analysis/mass spectrometry) data were consistent with those described in the literature.

3,4,5-Tris(11′-acryloyloxyundecyloxy)benzoyl chloride (3). This compound was synthesized as previously described in the literature [Zhou, W.-J.; Gu, W.; Xu, Y.; Pecinovsky, C. S.; Gin, D. L. Langmuir 2003, 19, 6346-6348.] Post-reaction, the solvent was removed under reduced pressure and the product was dried in vacuuo (<30 mtorr) at ambient temperature for 1 h in preparation for the next reaction protocol.

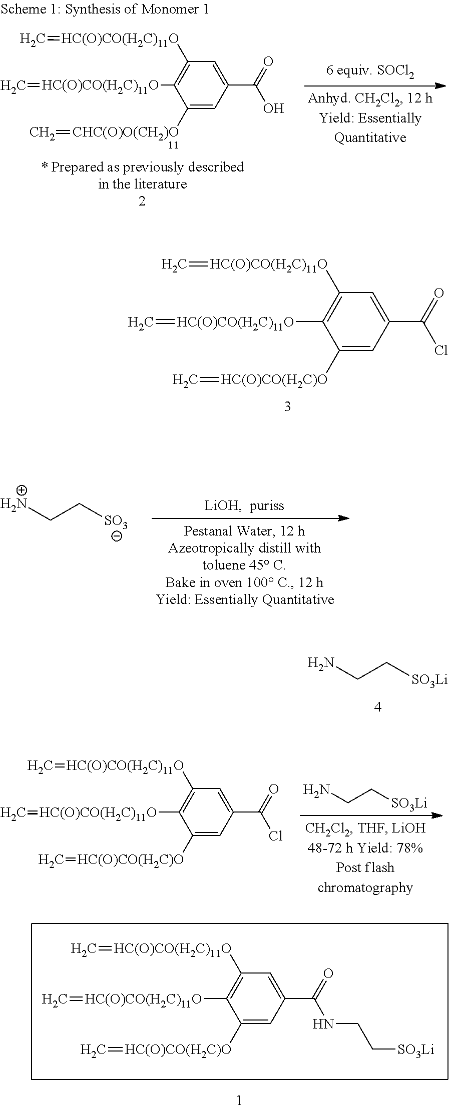

Lithium-2-aminoethanesulfonate (4). Taurine (i.e., 2-aminoethansulfonic acid) (10.00 g, 79.90 mmol) was added to High Purity Water (Burdick and Jackson, 15 mL) with vigorous stirring in a 50-mL round-bottom flask. When completely dissolved, puriss-grade lithium hydroxide monohydrate (3.52 g, 83.8 mmole) was added. Reaction was stirred at room temperature (22±1° C.) for 12 h. Toluene was then added, and the mixture was heated to 45° C. on a rotary evaporator to azeotropically remove the water under mild reduced pressure. The product was then placed in an oven at 100° C. for 12 h to complete the dehydration. The resulting solid was then ground by hand in a mortar and pestle maintained at 100° C. to achieve a finely powdered material. The powdered product was then placed in a dessicator for storage. Yield: 10.02 g (96%). ¹H NMR (500 MHz, DMSO): δ 2.78 (t, J=6.3, 2H), 2.52 (t, J=6.3, 2H). ¹³C NMR (101 MHz, D₂O): δ 36.50, 53.18. HRMS for C₂H₆LiNO₃S (M+H)⁺: 132.0306. found: 132.0312.

### Lithium-2-(3,4,5-tris(11′-(acryloyloxy)undecyloxy)benzamido)-ethanesulfonate (1)

(a) Synthesis of crude 1. Compound 3 (3.02 g, 3.51 mmole) was dissolved in a solution comprised of 125 mL of dry CH₂Cl₂ and 12.5 mL of fresh THF in a flame-dried, 200-mL Schlenk flask at room temperature. Puriss-grade lithium hydroxide monohydrate (0.736 g, 17.5 mmole) was then added to the solution. With vigorous stirring, compound 4 (2.30 g, 17.5 mmole) was then added to the flask contents. The reaction mixture was heated at reflux (46° C.) under an Ar atmosphere for 72 h with stirring. The reaction mixture was then removed while warm, separated into equal aliquots, placed into 40-mL glass centrifuge tubes, and centrifuged at 1900 rpm for 25 min. The supernatant was then decanted off and saved. The separated solids were washed three times with dry CH₂Cl₂, centrifuged, and the CH₂Cl₂ fractions were added to the previously collected organic aliquots. Two to three crystals of BHT were added prior to removing the solvent under reduced pressure to prevent potential polymerization of the acryloyl tails. A clear, very viscous liquid or tacky solid was obtained with a very slight yellow hue. This material was immediately dissolved in the minimum amount of a 95/5 (v/v) CH₂Cl₂/MeOH solution necessary to completely dissolve the product, and transferred to a normal-phase silica gel flash chromatography column for separation. The column was eluted with 500 mL of the same 95/5 (v/v) CH₂Cl₂/MeOH solution, and then the eluent was changed to 85/15 (v/v) CH₂Cl₂/MeOH and flash chromatography was run again. The final collected flash chromatography fractions were then reduced to dryness on a rotary evaporator, affording the desired product as a clear, tacky, slightly yellow, extremely viscous semi-solid or solid material. Yield: 2.42 g (72%). 1H NMR (500 MHz, d6-DMSO): δ 8.44 (t, J=5.5, 1H), 7.07 (s, 2H), 6.29 (dt, J=17.3, 1.4, 3H), 6.13 (ddd, J=17.3, 10.3, 2.6, 3H), 5.90 (dd, J=10.3, 1.5, 3H), 4.06 (td, J=6.6, 2.0, 6H), 3.95 (t, J=6.1, 4H), 3.85 (t, J=6.3, 2H), 3.54-3.46 (m, 2H), 3.36 (s, 3H), 2.71-2.64 (m, 2H), 1.75-1.66 (m, 4H), 1.59 (tt, J=13.4, 6.6, 9H), 1.47-1.36 (m, 7H), 1.27 (d, J=27.6, 39H). ¹³C NMR (101 MHz, d6-DMSO): δ 166.12, 166.10, 165.86, 152.86, 140.09, 131.92, 130.13, 129.03, 129.02, 105.95, 73.03, 68.97, 64.70, 64.68, 51.11, 40.78, 40.58, 40.37, 40.16, 39.95, 39.74, 39.53, 36.87, 30.48, 29.84, 29.75, 29.72, 29.66, 29.61, 29.52, 29.48, 29.39, 29.37, 28.77, 26.32, 26.09, 26.07. FT-IR (cm−1): 3471, 3263, 3070, 2929, 2854, 1725, 1683, 1675, 1670, 1652, 1637, 1620, 1581, 1550, 1499, 1467, 1457, 1446, 1427, 1408, 1386, 1374, 1340, 1298, 1270, 1195, 1119, 1060, 1003, 958, 963, 812, 795, 718, 696, 561, 522, 432. HRMS for C₅₁H₈₂LiNO₁₃S (M+Li)⁺: calculated: 956.2. found: 962.5 (difference in m/z attributed to one additional lithium ion coordinated to the parent molecule). Anal. Calcd for pure C₅₁H₈₂LiNO₁₃S: C, 64.06; H, 8.64; N: 1.46, Li: 0.73, S: 3.35. *Found: Na: 0.179, Cl: 0.12. Although spectroscopic data confirmed that the product prepared by the above method was indeed monomer 1, elemental analysis showed that it also contained a small amount of free Na⁺ and Cl⁻ (salt contaminants). Unfortunately, more detailed elemental analysis was not possible on the crude 4 obtained without further purification. Consequently, it was decided to remove as much of the free NaCl contamination as possible to minimize the potential impact these free ions would have on EIS/conductivity testing and to obtain acceptable elemental analysis results (see purification procedures below).

(b) Washing of crude monomer 1 to remove NaCl salt contamination. Crude compound I, as synthesized above, (0.958 g, 1 mmole) was dissolved in dry CH₂Cl₂ (20 mL) in a 40-mL glass centrifuge tube under an Ar atmosphere in a glove box. Pestanal water (10 mL) was added to the tube. The tube was then mixed with a glass stir rod vigorously for 1 min. A white emulsion-like layer formed in the tube, which will not break up under normal conditions. The resultant emulsion was then cycled twice on the centrifuge at 1900 rpm for 25 min to break the emulsion. The aqueous layer is removed and the water wash is repeated twice, as above, for a total of 3 wash cycles. Upon completion of the last cycle, the CH₂Cl₂ layer was removed using an 8 inch long, 16-gauge Luer-Lok needle attached to a syringe. The CH₂Cl₂ layer was then placed into a round-bottom flask, and the solvent removed under reduced pressure to dryness. The sample was then dried in vacuo (<20 mtorr) at ambient temperature for 24 h. Yield: 1.687 g (87%). Pre-Pestanal-water-wash levels of NaCl: Na: 0.166, Cl: 0.12. Post-Pestanal-water-wash levels of inorganic elements: Li: 0.512, Na: 0.179, Cl: 384 ppm. *Unfortunately, the Li content of water-washed 1 was found to be slightly low due to Li⁺ for H⁺-exchange/disproportion with the water in the aqueous wash layers, necessitating a back-titration with LiOH to give analytically pure 1. The presence of some of the sulfonic acid form of 1 (monomer 1A) was confirmed by the presence of a ¹H NMR signal at δ 12.4 (—SO₃H) in d₆-DMSO, as confirmed by ¹H NMR analysis of a sample of pure 1A in d₆-DMSO.

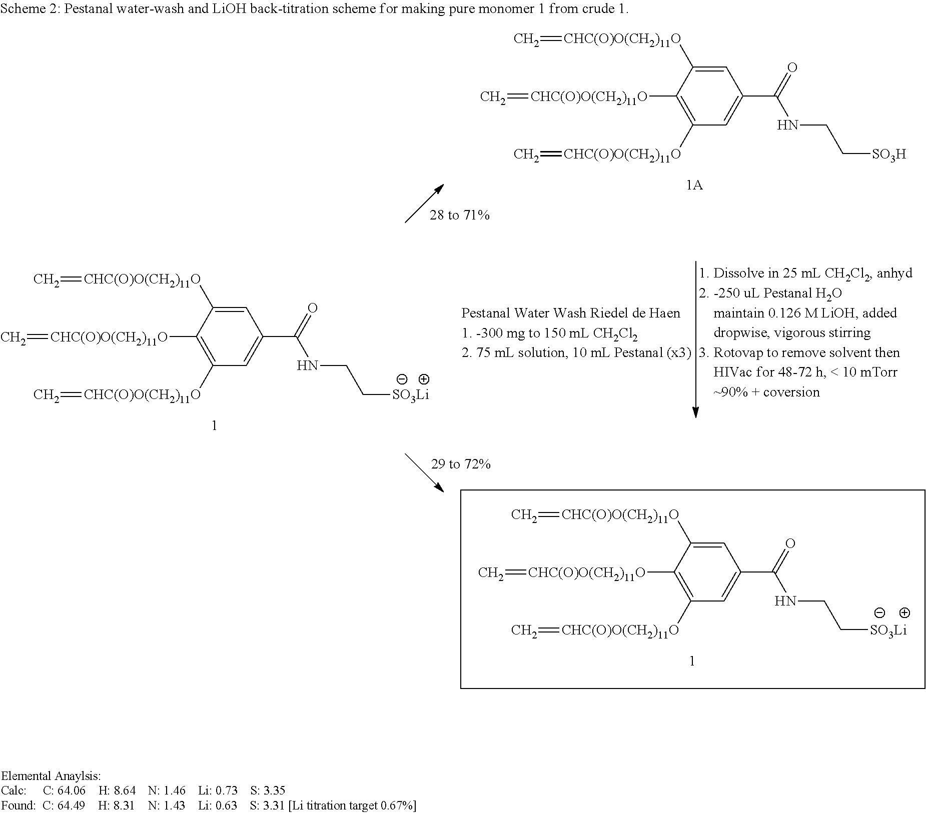

(c) LiOH back-titration of water-washed 1 to afford analytically pure 1. Post-water wash, it was found that some of the Li⁺ in the prepared monomer 1 had undergone ion exchange with H⁺ from the water wash. Typically, about 40 mol % of monomer 1 undergoes disproportionation/ion-exchange to the sulfonic acid form (1A) (see Scheme 3) when washed with pure water, but as much as 63.8% has been seen. Elemental analysis of water-washed 1 showed that the Li content was 0.512%, indicating that it was now a mixture of the sulfonic acid form (monomer 1A) and desired lithium salt form (monomer 1). In order to obtain analytically pure 1, this mixture of water-washed (1+1A) was back-titrated with aq. LiOH solution to convert any formed 1A back to 1 (Scheme 2). Typically, the amount of LiOH solution used in the back-titration was targeted to give 0.67% Li in the final sample based on initial Li elemental analysis data on the water-washed sample, so as not to exceed the 0.73% Li theoretical limit expected for pure 1 (and thereby introduce additional free salt contaminant).

Typical LiOH back-titration procedure: Water-washed 1 (0.138 g, 0.144 mmole) was added to dry CH₂Cl₂ (25 mL) in a flame-dried, 50-mL round-bottom flask. Puriss-grade lithium hydroxide monohydrate (0.0056 g, 0.133 mmole) was dissolved in Pestanal water (250 μL) to give a stock 0.126 M aq. LiOH solution. This LiOH solution was then added dropwise by micropipet into the water-washed 1/CH₂Cl₂ solution. The resulting Solution was stirred vigorously under an Ar atmosphere for 24 h. A single crystal of BHT (butylated hydroxytoluene) was added to prevent any unintended radical polymerization during the solvent removal process. The solvent was removed under reduced pressure to dryness and then dried in vacuo on the Schlenk line at ambient temperature until a pressure of <10 mtorr was achieved. Typically, this was accomplished within 24 h. Yield: 0.137 g, (ca. 100%). ¹H NMR (500 MHz, d₆-DMSO): δ 8.44 (t, J=5.5, 1H), 7.07 (s, 2H), 6.29 (dt, J=17.3, 1.4, 3H), 6.13 (ddd, J=17.3, 10.3, 2.6, 3H), 5.90 (dd, J=10.3, 1.5, 3H), 4.06 (td, J=6.6, 2.0, 6H), 3.95 (t, J=6.1, 4H), 3.85 (t, J=6.3, 2H), 3.54-3.46 (m, 2H), 3.36 (s, 3H), 2.71-2.64 (m, 2H), 1.75-1.66 (m, 4H), 1.59 (tt, J=13.4, 6.6, 9H), 1.47-1.36 (m, 7H), 1.27 (d, J=27.6, 39H). ¹³C NMR (101 MHz, d₆-DMSO): δ 166.12, 166.10, 165.86, 152.86, 140.09, 131.92, 130.13, 129.03, 129.02, 105.95, 73.03, 68.97, 64.70, 64.68, 51.11, 40.78, 40.58, 40.37, 40.16, 39.95, 39.74, 39.53, 36.87, 30.48, 29.84, 29.75, 29.72, 29.66, 29.61, 29.52, 29.48, 29.39, 29.37, 28.77, 26.32, 26.09, 26.07. FT-IR (cm⁻¹): 3471, 3263, 3070, 2929, 2854, 1725, 1683, 1675, 1670, 1652, 1637, 1620, 1581, 1550, 1499, 1467, 1457, 1446, 1427, 1408, 1386, 1374, 1340, 1298, 1270, 1195, 1119, 1060, 1003, 958, 963, 812, 795, 718, 696, 561, 522, 432. Anal. Calcd for pure C₅₁H₈₂LiNO₁₃S: C, 64.06; H, 8.64; N: 1.46, Li: 0.73, S: 3.35. Found: C, 64.49; H, 8.31; N, 1.43, Li: 0.625, S: 3.31, Na: 0.146, Cl: 668 ppm for the final LiOH back-titrated sample. Na and Cl content checked as contaminants only in an attempt to minimize free foreign salt impact on ion conductivity results.

### Example 3

### Q_{II} Phase Formation and Polymerization of Pure 1

Pure monomer 1 (0.0689 g, 7.52×10⁻⁵ mole) was placed into a clean, dry glass microtube in a Scienceware glovebox under Ar purge. 15 wt % Anhydrous 0.245 M LiClO₄/propylene carbonate (PC) solution (0.0103 g, 9.05 μL) was added to the tube by micropipet. The radical photoinitiator, 2-hydroxy-2-methylpropiophenone (0.000689 g, 0.67 μL), was then added to the microtube by pipet. The microtube was immediately sealed to prevent evaporation of the PC and absorption of water, and then placed in an aluminum block heater set at (55.5±0.5)° C. for 6 min to thermally equilibrate. After 6 min, the microtube and contents were centrifuged at 3800 rpm for 25 min. The contents of the microtube were then mixed by hand using a small spatula inside the Ar-filled glovebox with the sealing film left in place for 3 min. The centrifuge-hand mix process was then repeated a total of 4 times. The final mixture was optically transparent, very viscous, and had a slight yellow color.

The formation of the Q_{II} phase in this initial monomer 1-PC solution mixture was confirmed by POM and XRD analyses. This material was then transferred to a preheated ((55.0±0.5)° C.) quartz plate. A spacer of the desired thickness (e.g., 100 μm) was placed in on the same face as the 1-PC monomer mixture. Another preheated quartz plate (same dimensions and temperature as the first) was then placed directly on top of the first plate, thereby sandwiching the LLC monomer phase between the plates. The sandwiched sample was then placed on an aluminum block heater to maintain the temperature at (55.5±0.5)° C. for 2 min, removed from the heater, and then clamped with 3 to 4 large alligator clips depending on the sample size. Gentle downward hand pressure was exerted on the quartz plates until the LLC monomer gel stopped flowing due to the film thickness spacers. The sandwiched sample was then allowed to cool (approximately 1 h) undisturbed, to room temperature ((22±1)° C.) and then placed under the 365 nm UV lamp for cross-linking for 65 min at a UV light flux of 660 μW cm⁻². The resulting film samples were then cooled to room temperature in the glovebox under light Ar purge, removed from the glass slides, and placed in polyethylene zip-top bags. The zip-top bags were then sealed and transferred to a desiccator for storage until needed for AC impedance testing. FTIR analysis showed>95% degree of acrylate polymerization by comparison of the peak signal, pre- and post-photolysis, of the characteristic C—H stretch attributed to the acrylate groups at 811 cm⁻¹. Low-angle XRD analysis confirmed the presence of a Q phase with d-spacings corresponding to the 1/√6, 1/√8, 1/√9, 1/√10, 1/√12 peaks indicative of a Q phase with/or P space symmetry.

### Example 4

### AC Impedance Testing of Cross-Linked Q_{II}-Phase Films of 1

The impedance analyzer was set up according to the manufacturer's instructions and calibrated against internal and external standards to determine that it was within normal operational parameters. A cross-linked Q_{II}-phase film of 1 was removed from the polyethylene zip-top bag and inserted into a custom-machined test fixture, tightened down gently, and connected to the lead wires on the impedance analyzer. The test fixture was comprised of a solid block of machined PTFE and fitted with micro-polished, antimagnetic, stainless steel, adjustable probes with a contact face diameter of 22.2 mm (0.875 inches). One probe was purchased with an articulating joint to enable even surface contact at the probe-film interfaces. The AC impedance of the film samples was tested by sweeping the frequency from 1000 Hz to 1, 3, or 5 MHz depending on the protocol. R and X values were collected in ohms for each frequency. This was followed by analysis on a spreadsheet program capable of handling imaginary number calculations. In order to confirm the accuracy of the extrapolated solution resistance and ion conductivity values obtained from the X vs. R (Nyquist) plots, the system and testing method were calibrated with commercial Nafion-1135 polyelectrolyte films that have a known range of resistance and ion conductivity in the literature [S. Slade, S. A. Campbell, T. R. Ralph and F. C. Walsh J. Electrochem. Soc. 2002, 149, A1556-A1564, and references therein]. The values for commercial Nafion-1135 films using this testing apparatus were in the middle of the reported ranges for this Nafion-1135 in the literature. In addition, the diameter of the test films and the test electrodes were varied systematically to ensure that the observed solution resistance and ion conductivity values of the films were not due to possible solution leakage around the edges of the sample between the test electrodes.

Discussion of Results with LLC monomer 1

LLC monomer 1 can be synthesized as detailed above. The work-up and purification described for the monomer was used to ensure high purity (confirmed by elemental analysis) and to ensure that it is free of common contaminant ions such as Na⁺ and Cl⁻ that might contribute to an overestimate of the intrinsic Li ion conductivity. Extremely pure reagents, water, organic solvents, and salts were used as described to achieve the high level of purity and sample homogeneity. Other monomers useful in the methods herein can be synthesized by one of ordinary skill in the art in view of the methods provided herein and what is known in the art. One of ordinary skill in the art can readily adapt methods herein for use in preparation of other such materials in view of what is well-known in the art. The following references provide additional details useful for the preparation of the materials of this invention: Pindzola et al. (2003) J. Amer. Chem. Soc. 125:2940-2949; U.S. provisional application 61/299,416, filed Jan. 29, 2010; U.S. application 2008-0029735-A1, published Feb. 7, 2008. Phosphonate (—PO₃²⁻) salt LLCs useful in this invention can, for example, be prepared employing methods as describe in Hammond et al. (2002) Lig. Cryst. 29:1151-1159 and references cited therein. Each of these references is incorporated by reference herein in its entirety for descriptions of synthetic method and other techniques employed in the preparation and analysis of LLC materials.

The analysis that is provided hereafter can be applied to any of the polyelectrolyte materials of this invention.

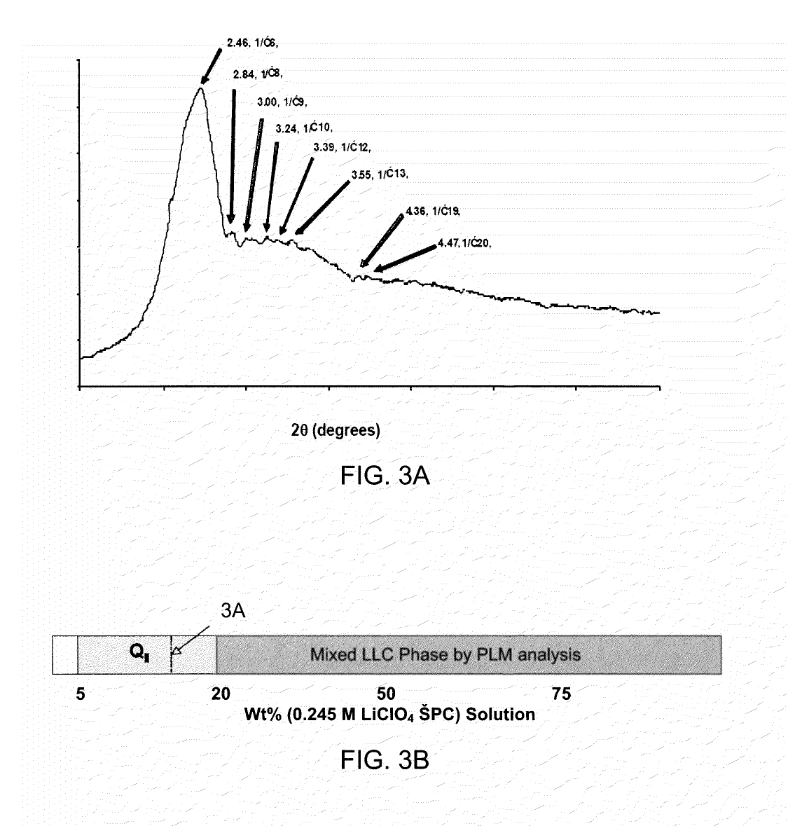

FIG. 3B shows the phase diagram of the purified 1/(0.245 M LiClO₄-PC) system at room temperature (23±1)° C. and ambient pressure (Boulder, Colo.). Powder X-ray diffraction (XRD) was used to confirm the geometry of the various LLC phases observed in this system, with the presence of a well-defined Q phase with either I or P symmetry identified by the presence of d-spacings in the ratio: 1/√6:1/√8:1/√11 . . . (FIG. 3A).⁹ The presence of a Q phase was also confirmed by the presence of a completely black (pseudo-isotropic) polarized light microscopy (PLM) texture for the thick gel-like LLC mixture, which is also indicative of a Q phase.⁹

The assignment of a type II phase for the observed Q phase observed in the 1/(0.245 M LiClO₄-PC) system was based on two suppositions, in lieu of direct observation of a lamellar (L) phase in the system. Normally, a L phase is considered to be the central point of an ideal LLC phase progression with no net curvature.^{7,8} Consequently, LLC phases on the solvent-excessive side of the L phase are termed type I and curve away from the solvent domains.

Conversely, phases that appear on the solvent-deficient side of the L phase are called type II and curve towards the solvent domains.^{7,8} In the case of the 1/(0.245 M LiClO₄-PC) system, only a mixed LLC phase on the solvent-rich side of the Q phase was observed. Since the observed Q phase exists at low solvent content (5-20 wt % (0.245 M LiClO₄-PC)), it is most likely a solvent-deficient type II phase.

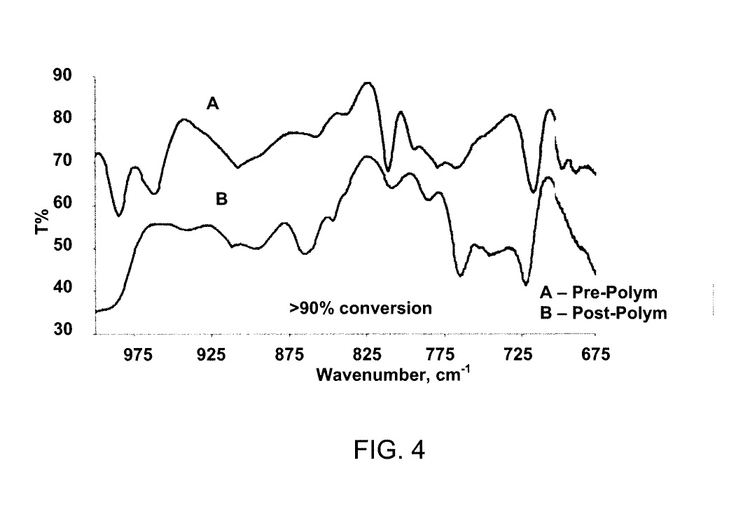

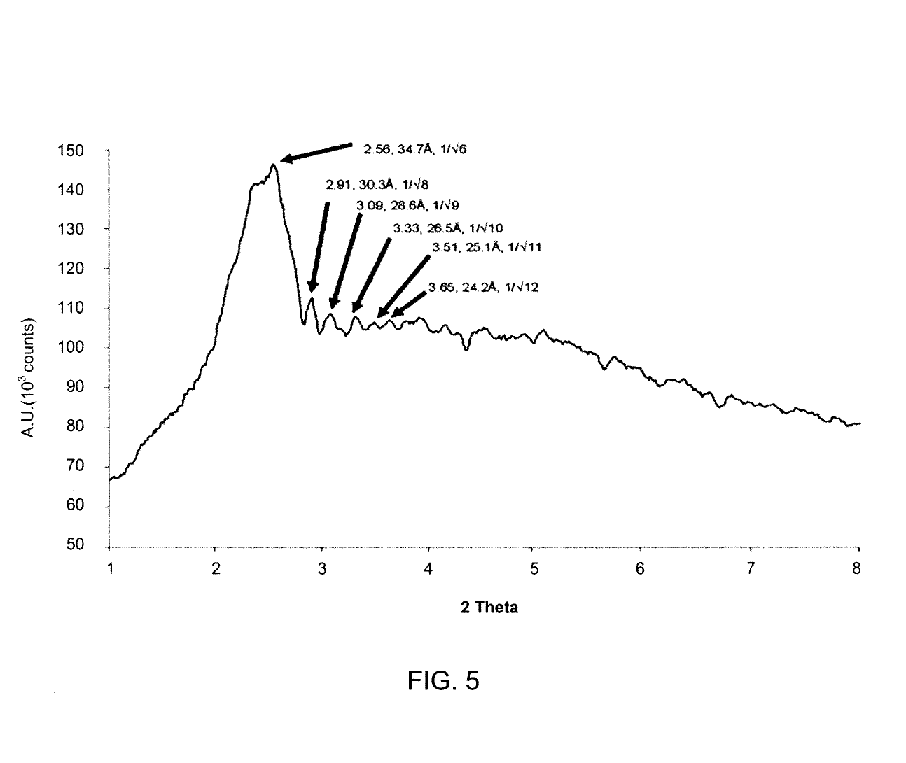

Films of the Q_{II} phase were stabilized by cross-linking the molecules of 1 together with retention of LLC order via photo-initiated radical chain addition polymerization with UV light. This was performed by manually pressing together a prepared Q_{II} phase gel of 1, PC/LiClO₄ solution, and photoinitiator between fused silica plates, and irradiating the sandwiched sample with 365 nm light at room temperature under an inert, dry atmosphere, as described in the Examples. The silica sandwich configuration was used not only to form films but also to prevent any PC evaporation from the sample surface during the photopolymerization process. FIG. 4 shows the FT-IR spectra and a digital picture of a free-standing, photo-cross-linked, Q_{II}-phase 1-PC/LiClO₄ film containing 15 wt % (0.245 LiClO₄-PC) solution, confirming a high degree of polymerization and good film qualities. In fact, the unique nanoporous LLC structure affords a very flexible polymer material even at ca. 95% acrylate conversion because cross-linking only occurs in thin regions where the tail ends meet, and the majority of the LLC structure is still flexible or solvent-filled. LLC monomer 1 behaves similarly and forms similar LLC phases with pure PC as the LLC solvent, instead of 0.245 M LiClO₄-doped PC. Thorough studies with 1 and pure PC (including a complete room-temperature phase diagram) were initially done prior to the use of a PC/LiClO₄ solution, in order to establish proof-of-concept for LLC compatibility of 1 with PC as a solvent. FIG. 5 shows a representative XRD profile and PLM texture (inset) of the cross-linked Q_{II} phase of 1 containing 15 wt % pure PC (no added LiClO₄ dopant). As described in the following sections, the ion conductivity of the non-Li salt-doped Q_{II} phase polymer composite was very low. Consequently, this 1/(pure PC) system was modified to form the LLC phase around a Li-salt-doped PC solution to provide higher free Li ion mobility.

Electro-impedance spectroscopy (EIS) measurements on the cross-linked Q_{II} phase 1-PC/LiClO₄ film samples were performed to measure their ionic conductivity. In the EIS method for determining ionic conductivity, an alternating electrical potential is applied to the sample, and the impedance (Z) of the sample (both the imaginary and real components) are monitored as a function of applied alternating current (AC) frequency.¹⁰⁻¹³ To understand this process, consider the simplified DC (direct current) electric circuit, without any capacitance, where V=IR, such that V is the applied electrical potential (in volts), I is the current (in amps), and R is the resistance (in ohms). Knowing the voltage and measuring the current allows calculation of the resistance. A purely capacitive system would respond to an AC signal by charging the capacitor on the upswing, and discharging on the downswing, such that the resulting response would match the input but would be exactly 90 degrees out of phase. A resistor and capacitor in series is called an “RC circuit”, and such a system would exhibit a real resistance, plus a phase shift. The magnitude of the resistance and capacitance can thus be calculated by examining the magnitude and phase of the impedance response of the material. For these systems, measurements of impedance are taken as the frequency of the current is changed from approximately 100 Hz to approximately 3 MHz or higher. These resistance values are termed R (real) and X (imaginary) and are both measured in ohms. By evaluating the impedance data (R and X) as well as knowing the sample thickness and diameter, conductivity data can be derived for each sample in units of siemens per cm (i.e., S cm⁻¹).

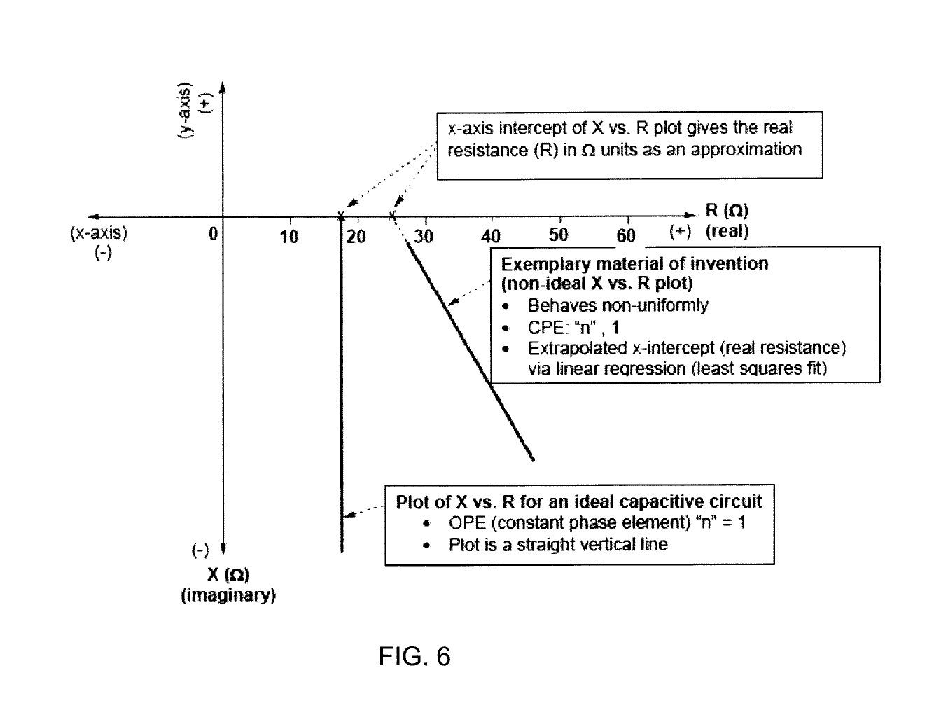

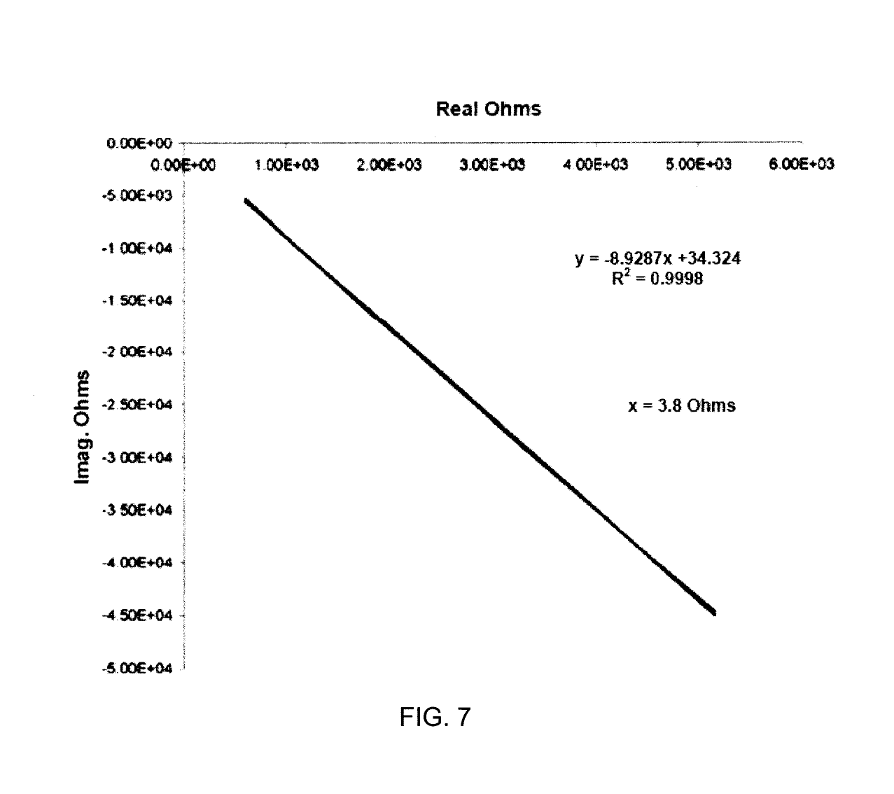

From this frequency-dependent imaginary (X) and real (R) impedance data, a Nyquist plot is generated for the sample, from which bulk composite ion conductivity (of the sample) can be determined by a simple linear fit. FIG. 6 below shows what Nyquist plots typically look like for different types of ion-conductive and capacitive materials, and how the resistance values for a sample are extrapolated. One complexity of the LLC systems is that the material does not behave ideally, and can only be fit by assuming a constant phase element (CPE), which is commonly seen in materials tested using non-uniform (e.g., rough) electrodes. In these systems, the data imply that there is a non-uniform and non-conductive ‘skin’ layer that forms on the outside of the film. All of the data for LLC systems fit to a CPE of >0.9, usually around 0.93 to 0.96.¹⁰⁻¹³ Using these methods and collected EIS data, free-standing 100 μm thick films of the Q_{II}-phase of cross-linked 1 containing 15 wt % (0.245 M LiClO₄-PC) were determined to have a room-temperature bulk ion conductivity of ca. 10⁻⁴ to 10⁻³ S cm⁻¹. A representative Nyquist plot for a Q_{II} phase film of cross-linked 1 containing 15 wt % (0.245 M LiClO₄-PC) is shown in FIG. 7, as well as the extrapolated conductivity values from the plot. Once the plot of X and R has been made, linear fit provides the value of the x-intercept. The x-intercept corresponds to the bulk resistance for the nanocomposite Q_{II} phase films. Once the resistance in ohms has been determined and the film thickness and diameter are known, the conductivity in S cm⁻¹ can be calculated.

From FIG. 7, the x-intercept of the Nyquist plot for a typical cross-linked Q_{II} film of 1 containing 15% (0.245 M LiClO₄-PC) gives a range of 3 to 21 ohms, allowing for reasonable error (avg.=19 ohms, std. dev.=±11 ohms). Based on the diameter and thickness of the test film, the calculated conductivity is 10⁻⁴ to 10⁻³ S cm⁻¹. This bulk ionic conductivity value is on par with the best Li ion conducting solid polymer electrolyte and gelled (i.e., liquid electrolyte-swollen or plasticized) PEO-based electrolyte materials known in the literature. It also approaches the values bench-marked by liquid electrolytes doped with free inorganic Li salts (10⁻³ to 10⁻² S cm⁻¹ at room temperature^{2,3}. It should be noted that the bulk solution conductivity values obtained using this method and measurement system were verified using a commercial Nafion-117 film, with reported ranges of ionic conductivity in the literature, as a calibration standard. The observed resistance and conductivity values of a hydrated Nafion-117 film tested with the aforementioned method and apparatus were right in the middle of the reported ranges for these values. The aforementioned Q_{II}-phase polymer-liquid nanocomposite has a 3-D interconnected nanopore system containing the Li⁺ ions and PC solvent. Without wishing to be bound by any particular theory, it is this PC-based nanoporous structure that is believed to provide good liquid-like Li⁺ mobility in a flexible, solid polymer morphology.

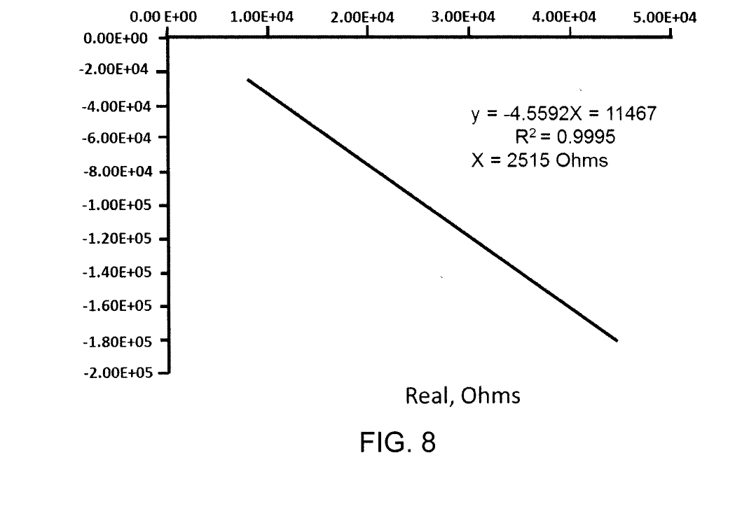

In contrast, EIS measurements on free-standing films of the cross-linked Q_{II} phase of 1 containing 15 wt % of pure PC (no added LiClO₄) revealed bulk ion conductivity values that are approximately 3-orders-of-magnitude lower than analogous samples containing 0.245 M LiClO₄. This translates to an observed bulk ion conductivity of ≦10⁻⁶ S cm⁻¹ at room temperature for these 1/pure PC control samples. FIG. 8 shows the detailed Nyquist plot and AC electrical impedance behavior of these Li-salt-dopant-free control materials and the extrapolated ion conductivity values. In the absence of added free Li salts to the liquid component of these liquid-nanochannelled ionic LLC polymers, conductivity values of ca. 10⁻⁶ S cm⁻¹ are obtained. These values are similar to those exhibited by typical polyelectrolyte materials.³ The addition of small Li salt dopants to the liquid component of these LLC materials results in higher bulk Li ion mobility and conductivity at room temperature.

The high extrapolated solution component and bulk ion conductivity values observed indicate that the Li-salt-doped, PC-filled LLC networks have very liquid-like Li ion transport behavior, but in a robust, flexible, solid polymer morphology. This unusual ion transport behavior is likely a direct manifestation of the fact that the LLC polymer material has phase-separated, interconnected, liquid transport pathways on the nanoscale through which the dopant Li ions move easily, while the cross-linked LLC polymer matrix provides the structural support and containment desired for a solid electrolyte. In contrast, typical gelled polymer electrolytes do not have such an ordered, phase-separated liquid-solid structure, but rather they have a homogeneous morphology of liquid electrolyte or plasticizer blended or intimately mixed directly into the polymer chains.³ These “typical” plasticized gels have poor mechanical properties and require high loadings of liquid to achieve reasonable (ca. 10⁻⁴ S cm⁻¹) conductivities.^{3,14} They, inherently, must trade-off mechanical properties for electrical properties and vice versa. Typically a range of 40 to 60% liquid is required to achieve 10⁻⁴ S cm⁻¹ or better, and maintain very limited mechanical properties inherent to the polymer.³ The nanostructured composite material of the present invention has low liquid loading percentages in comparison to gelled systems, but equal or superior conductivity and is expected to possess much better mechanical properties overall. Furthermore, most if not all, gelled polymer electrolyte systems show logarithmic behavior in their conductivities, whereas the material of the present invention behaves in an atypical linear fashion.

The high room-temperature bulk ion conductivity of 10⁻³ to 10⁻⁴ S cm⁻¹ observed for the cross-linked Q_{II} phase 1-PC/LiClO₄ films were obtained on samples made with 15 wt % of a solution of 0.245 M LiClO₄ in PC. Typically, Li salt doped, gelled PEO materials are prepared with a 1.0 M concentration of free Li salt in the liquid electrolyte additive. Higher ionic conductivity values for the claimed LLC materials may be possible if higher wt % of (0.245 M LiClO₄ in PC) solution were used in the LLC phase preparation to include a larger amount of the conductive Li salt solution in the composite material. The observed room-temperature Q_{II} phase of 1 can tolerate up to 20 wt % of this Li salt-doped electrolyte solution with phase retention (FIG. 3B). In addition, higher conductivity values for these materials may also be achieved by using PC solutions with higher LiClO₄ (or related Li salt dopant) concentrations up to and exceeding 1.0 M. LLC compatibility studies with 1 and a 1.0 M LiClO₄ in PC solution have already shown evidence of formation of a stable room-temperature Q_{II} phase. However, there is evidence of some LiClO₄ microcrystal formation in this more salt concentrated system, most likely due to crystal seeding via confinement of the 1.0 M LiClO₄ in PC solution in the ionic LLC nanochannels.

### Example 5

### Procedure for LLC Phase Formation and Photo-Cross-Linking of 1 with PC and PC-LiClO₄ Solutions (50 Wt %)

Pure monomer 1 (0.0355 g, 3.71×10⁻⁵ mole) was placed into a clean, dry glass microtube (10 mm I.D. and 30 mm length) in a Scienceware glovebox under Ar purge. 50 wt % Anhydrous 0.245 M LiClO₄/propylene carbonate (PC) solution (0.0178 g, 15.55 μL) was added to the tube by micropipet. The radical photoinitiator, 2-hydroxy-2-methylpropiophenone (0.000355 g, 0.32 μL), was then added to the microtube by pipet. The microtube was immediately sealed to prevent evaporation of the PC and absorption of water, and then placed in an aluminum block heater set at (55.5±0.5)° C. for 6 min to thermally equilibrate. After 6 min, the microtube and contents were centrifuged at 3800 rpm for 25 min. The contents of the microtube were then mixed by hand using a small spatula inside the Ar-filled portable glovebox with the sealing film left in place for 3 min. The centrifuge-hand mix process was then repeated a total of 4 times. The final mixture was optically transparent, very viscous, and had a slight yellow color. The formation of the resultant LLC phase in this initial monomer 1-PC solution mixture was confirmed by PLM and powder XRD analyses. This material was then transferred to a preheated ((55.0±0.5)° C.) quartz plate. A spacer of the desired thickness (e.g., 100 μm) was placed in on the same face as the 1-PC monomer mixture. Another preheated quartz plate (same dimensions and temperature as the first) was then placed directly on top of the first plate, thereby sandwiching the LLC monomer phase between the plates. The sandwiched sample was then placed on an aluminum block heater to maintain the temperature at 55.5±0.5° C. for 2 min, removed from the heater, and then clamped with 3 to 4 large alligator clips depending on the sample size. Gentle downward hand pressure was exerted on the quartz plates until the LLC monomer gel stopped flowing due to the film thickness spacers. The sandwiched sample was then allowed to cool (approximately 1 h) undisturbed, to room temperature ((21±2)° C.) and then placed under the 365 nm UV lamp for cross-linking for 65 min at a UV light flux of 660 μW cm⁻². The resulting film samples were then cooled to room temperature in a portable glovebox under light Ar purge, removed from the glass slides, and placed in polyethylene zip-top bags. The zip-top bags were then sealed and transferred to a desiccator for storage until needed for AC impedance testing.

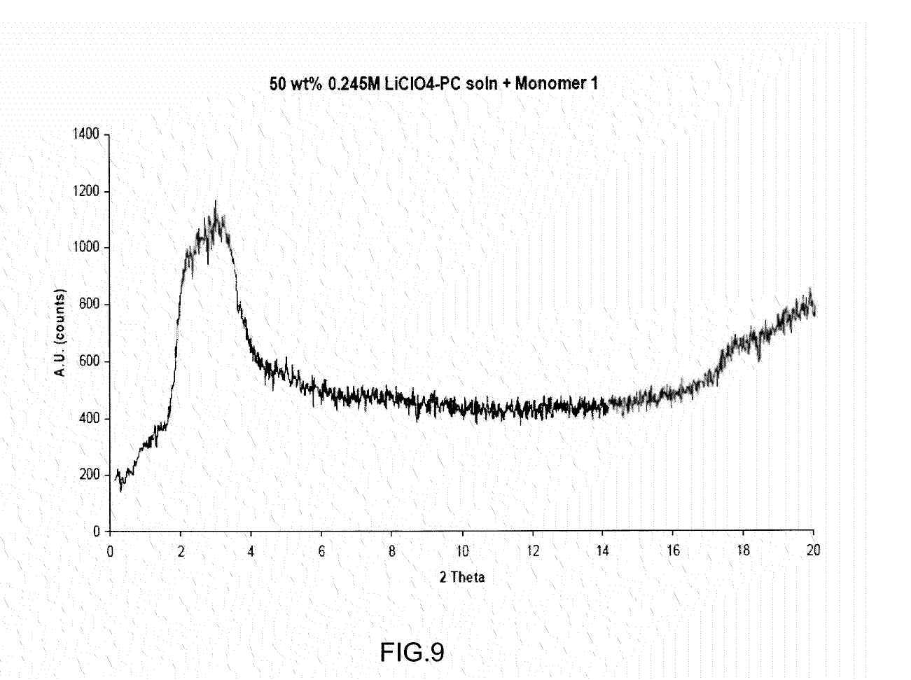

Low-angle XRD analysis (FIG. 9) and polarization light microscopy (PLM, not shown) showed a low level of ordering and confirmed the presence of an LLC phase with an unknown phase or mixed phase which is likely a mixture of loosely ordered LLC phases. AC impedance measurements performed on this material (using stainless steel blocking electrodes) exhibited the typical semi-circular Nyquist plot behavior desired in Li battery electrolyte materials, as a dimensionally stable, flexible, gelled polymer electrolyte film (FIG. 10). The AC impedance and observed room-temperature Li ion conductivity (ca. 10⁻³ S cm⁻¹) show this material to be valuable as a battery electrolyte material, even though its morphology is not well-defined, in contrast to the highly uniform Q_{II} phase material described above at lower solvent levels.

A mixture of monomer 1 and 30 wt % anhydrous 0.245 M LiClO₄/propylene carbonate (PC) solution was cross-linked analogously to the 50 wt % liquid electrolyte material as described above. Low-angle XRD analysis (FIG. 11) and polarization light microscopy (PLM, not shown) confirmed the presence of an LLC phase.

### Example 6

### Polymer Electrolytes Formed From Photopolymerization of Monomer 1 in Various Liquid Electrolytes

Table 1 provides the results of conductivity measurements of polymer electrolytes formed from monomer 1 (as described above) in several exemplary liquid electrolytes. Liquid electrolytes including alkylene carbonate solvents (propylene carbonate) and mixtures of aprotic solvents (alkylene carbonates and ethers) with lithium salts are exemplified. Li salt concentration is as indicated.

TABLE 1
Conductivity measurements of Exemplary Polymer
Electrolytes of the Invention

| | Solvent in | Conductivity |
|---|---|---|
| Solvent type % | final material | (10⁻³ S/cm) |
| 1M LiPF₆ in EC/DME (33:67) | 28.6 wt % | 3.1 |
| 1M LiPF₆ in EC/DME (33:67) | 23.0 wt % | 0.9 |
| 1M LiClO₄ in EC/DME (33:67) | 28.6 wt % | 2.4 |
| 1M LiClO₄ in EC/DME (33:67) | 23.0 wt % | 1.5 |
| 1MLiClO₄ in EC/DMC (50:50) | 28.6 wt % | 0.9 |
| 1M LiClO₄ in EC/DMC (50:50) | 23.0 wt % | 1.8 |
| 1M LiClO₄ in PC | 28.6 wt % | 1.2 |
| 1M LiClO₄ in PC | 23.0 wt % | 1.1 |

EC = ethylene carbonate;
DME = 1,2-dimethoxy ethane;
DMC = dimethyl carbonate;
PC = propylene carbonate

### Example 7

### Lithium Battery Construction and Testing

A free-standing polyelectrolyte film was prepared from cross-linked polymer electrolyte material formed by photo cross-linking of the mixture of monomer 1 with PC-LiClO₄ solutions (50 Wt %). The film was successfully employed to make working Li batteries. The material was formed in to a free-standing film (not cast onto the cathode) and assembled into the lithium battery in a dry box. The sample electrolyte film was cut with a die, the surface was rewetted by immersing the cut film in electrolyte (1 M LiBF₄ in PC) for approx 5 minutes, excess electrolyte was removed by gently patting surface with a wipe (Kimwipes®, Kimberly Clark), and the film was then inserted into a CR2025 coin battery cell using standard assembly for that cell in the order spring, spacer, cathode, polyelectrolyte membrane (film) and Li metal foil within the cell housing and the cell was closed using a hand-crimping device. In this assembly the polyelectrolyte film was inserted between the lithium metal anode (FMC Lithium) and the conventional lithium-ion cathode material. A very small amount (˜1 mL) of electrolyte (1 M LiBF₄ in PC) was added to wet the interface between the electrolyte film and each electrode before assembly, but care was take to insure that only a very small amount was added so that there would be no potential for the liquid to spread to the edges of the membrane and potentially cause electrolyte bridging around the membrane.

The open circuit voltage of the battery sample cell was measured at 23° C. using a voltmeter. The sample cell was found to have an open circuit voltage of 3.2476. The ideal/theoretical voltage open circuit voltage for this cell is 3.3, thus the polymer electrolyte was providing an efficient on-conductive pathway from the anode and cathode.

The performance of a given polymer electrolyte in a given lithium battery configuration can also be assessed as is known in the art employing cycle tests—rate of charge/discharge and cycle lifetime.

Various cathode materials are commercially available, including LiNi_{0.8}CO_{0.15}Al_{0.05}O₂ cathode materials. Cathodes can be obtained commercially or can be made by art-known methods, for example, using wet casting. For example, a mixture of cathode powder SC 10 (EM Industries), which consists of Lithium Cobalt Oxide (Selectipur®), carbon and polyvinylidene fluoride (binder) can be wet cast onto an aluminum current collector. The wet cast film is dried, followed by compression and vacuum treatment. [Y. Aihara, et al; J. Power Sources vol 65 (1997) 143-147, which is incorporated by reference herein for details of such methods.]

1. A polymer electrolyte which comprises a polymer matrix and a liquid electrolyte, wherein the polymer matrix comprises one or more cross-linked ionic polymers, and the liquid electrolyte comprises an aprotic organic solvent and a free salt wherein the liquid electrolyte is contained within the polymer matrix.

2. The polymer electrolyte of claim 1 wherein the free salt is a lithium salt.

3. The polymer electrolyte of claim 1 wherein the aprotic organic solvent is selected from alkylene carbonates, alkoxyalkanes, dialkylcarbonates, cyclic esters or mixtures thereof.

4. The polymer electrolyte of claim 1 wherein the aprotic organic solvent is selected from tetrahydrofuran, 2-methyl tetrahydrofuran, dioxolane, dimethoxymethane, 1,2-dimethoxyethane, diethoxymethane, 1,2-diethoxyethane, ethylene carbonate, propylene carbonate, dimethylcarbonate, diethylcarbonate gamma-butyrolactone, gamma-valerolactone, methylformate, dimethyl sulfoxide, dimethyl sulfite, nitromethane, acetonitrile or miscible mixtures thereof.

5. The polymer electrolyte of claim 1 wherein the liquid electrolyte comprises a mixture of alkylene carbonates, alkoxyalkanes, dialkylcarbonates, or cyclic esters.

6. The polymer electrolyte of claim 1 wherein the polymer matrix is formed by cross-linking one or more polymer matrix precursors, wherein at least one of the polymer matrix precursors is a cross-linkable ionic monomer.

7. The polymer electrolyte of claim 6 wherein the cross-linkable ionic monomer is an ionic LLC surfactant.

8. The polymer electrolyte of claim 1 wherein the polymer matrix is at least in part covalently cross-linked.

9. The polymer electrolyte of claim 1 wherein the polymer electrolyte comprises from 10 wt % to 40 wt % of the liquid electrolyte.

10. The polymer electrolyte of claim 1 which comprises one or more LLC phases.

11. The polymer electrolyte of claim 6 wherein the cross-linkable ionic monomer has the formula: 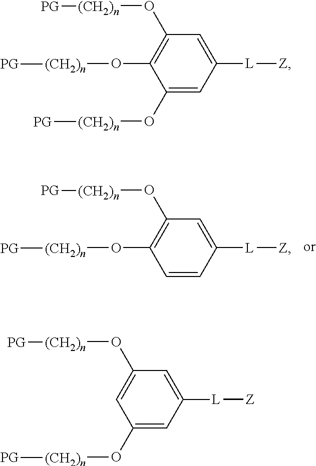
where
each n, independently, is an integer from 6-14, L is an organic diradical linker, Z is a Li-salt-containing ionic headgroup and PG is a chain-addition polymerizable group.

12. The polymer electrolyte of claim 11 wherein Z comprises one or more —SO₃⁻ or —PO₃²⁻ anions.

13. The polymer electrolyte of claim 11 wherein PG is an activated olefin.

14. The polymer electrolyte of claim 6 wherein the cross-linkable ionic monomer has the formula: 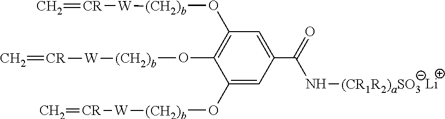
where a and b are integers and a is 1 to 6 and each b ranges from 6-14;
W is —O—CO—, —CO—O—, —CO—NH—, —O—, —C₆H₄—, or —C₆H₄—O—;
R is hydrogen or an alkyl group having 1-3 carbon atoms;
each R₁ and R₂ is hydrogen or an alkyl group having 1-3 carbon atoms, wherein R₁ and R₂ together can represent 2-4 alkyl groups.

15. The polymer electrolyte of claim 14 wherein the cross-linkable ionic monomer has the formula:

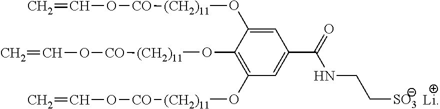

16. The polymer electrolyte of claim 1 wherein the free salt is a lithium salt and the concentration of the free lithium salt in the liquid electrolyte ranges from 0.75 to 1.25 M.

17. The polymer electrolyte of claim 1 which exhibits bulk ion conductivity greater than 10⁻⁴ S cm⁻¹ at room temperature.

18. The polymer electrolyte of claim 1 in the form of a film including a free-standing film.

19. A lithium battery comprising a polymer electrolyte of claim 1 which is optionally in the form of a film or free-standing film.

20. A method for making a polymer electrolyte which comprises the step of polymerizing the cross-linkable ionic monomer of claim 6 in the presence of a liquid electrolyte which comprises an aprotic organic solvent with a free lithium salt dissolved therein.
